(19) United States
(12) Patent Application Publication
(10) Pub. No.: US 2026/0126300 A1
(43) Pub. Date: May 7, 2026

(54) FEATURE DETECTION MODELS FOR AUTONOMOUS AND SEMI-AUTONOMOUS SYSTEMS AND APPLICATIONS

(71) Applicant: NVIDIA Corporation, Santa Clara, CA (US)

(72) Inventors: Kezhao Chen, Guangzhou (CN); Ruiqi Zhao, Shanghai (CN); Yujian Li, Changzhi (CN)

(21) Appl. No.: 18/937,513

(22) Filed: Nov. 5, 2024

(30) Foreign Application Priority Data
Nov. 1, 2024 (CN) 2024115541102

(51) Int. Cl. G01C 21/00

(52) U.S. Cl. CPC G01C 21/3822

(57) ABSTRACT

In various examples, feature detection models for autonomous and/or semi-autonomous systems and applications are described herein. Systems and methods described herein may use one or more trained machine learning models to automatically generate representations of traffic features corresponding to a map, such as road markings and/or road edges. For instance, the model(s) may take, as input, an image representing at least a portion of a map that includes one or more traffic features along with one or more indications of one or more points associated with the traffic feature(s) as represented by the image. Based at least on processing the inputs, the model(s) may generate and/or output data representing additional points associated with the traffic feature(s) and/or a heatmap representing one or more lines representing the traffic feature(s). This output data may then be used to determine the representation(s) of the traffic feature(s) for annotating the map.

### CROSS-REFERENCE TO RELATED APPLICATIONS

This application claims the benefit of Chinese Patent Application No. 2024115541102, filed Nov. 1, 2024, which is incorporated herein by reference in its entirety.

### BACKGROUND

For vehicles (e.g., autonomous vehicle, semi-autonomous vehicles, robots, etc.) to operate safely in environments, the vehicles must be capable of effectively performing vehicle maneuvers—such as lane keeping, lane changing, lane splits, turns, stopping and starting at intersections, crosswalks, and the like, and/or other vehicle or machine maneuvers. For example, for a vehicle to navigate through surface streets (e.g., city streets, side streets, neighborhood streets, etc.) and on highways (e.g., multi-lane roads), the vehicle is required to navigate among one or more divisions or demarcations (e.g., lanes, intersections, crosswalks, boundaries, etc.) of a road that are often marked using traffic features—such as road markings that include arrows, text, graphics, and/or other types of content. As such, it is important that the vehicles are able to detect the traffic features within the environments, such that the vehicles are able to determine how to navigate according to rules associated with the traffic features.

To detect traffic features, vehicles may, at least in part, use maps corresponding to the environments for which the vehicles are navigating. For example, the maps may be annotated to indicate the locations of important traffic features that the vehicles need to identify when navigating, such as road edges, road markings, traffic signs, and/or so forth. Some conventional approaches for annotating such maps includes users viewing various portions of the map in order to manually input the labels for the traffic features. For example, a user may manually indicate the location of a road marking by selecting a number of points that are located along the road marking—such as hundreds and/or thousands of points—for a given length of the road marking. However, causing users to manually indicate the locations of traffic features as represented by maps may be time consuming, be prone to user error, and/or require a large amount of computing resources (different user devices).

As such, and more specifically for road marking, other conventional approaches may use curve fitting functions to connect existing road marking that are already annotated on maps. For example, if users have already annotated a first portion of a road marking and a separate, second portion of the road marking, then these conventional approaches will just attach the two portions of the road marking together using a curve fitting function. However, by merely using curve fitting functions to connect existing road markings, these conventional approaches may be accurate with regard to straight road marking, but inaccurate for road markings that include one or more curves. Additionally, since these conventional approaches operate on an entirety of a map, the generated annotations for the road markings may not align when the map is segmented into sub-sections (e.g., images), such as for providing the map to vehicles for navigating.

### SUMMARY

Embodiments of the present disclosure relate to feature detection models for autonomous and/or semi-autonomous systems and applications. Systems and methods described herein may use one or more trained machine learning models (the model(s)) to automatically generate representations of traffic features corresponding to a map, such as road markings and/or road edges. For instance, the model(s) may take, as input, an image representing at least a portion of a map that includes one or more traffic features along with one or more indications of one or more points (e.g., one or more prompts) associated with the traffic feature(s) as represented by the image. Based at least on processing the inputs, the model(s) may generate and/or output data representing additional points associated with the traffic feature(s) and/or a heatmap representing one or more lines corresponding to the traffic feature(s). In some examples, the model(s) and/or another postprocessing component may then determine one or more final representations for the traffic feature(s) using the outputs—such as line representations for road markings and/or road edges—which may then be used to annotate the map.

In contrast to conventional systems, the systems of the present disclosure, in some embodiments, are able to use the prompts and/or the input images to automatically determine the locations of traffic features as represented by maps. This way, the systems of the present disclosure do not require users to manually input all of the points for the traffic features—such as hundreds and/or thousands of points—when annotating the maps. Additionally, and as described in more detail herein, the model(s) may be trained to determine a number of points associated with the traffic features—such as up to one hundred or more points—that are then used to determine the final representations (e.g., line representations) for the traffic features within the map. As such, the systems of the present disclosure may generate more accurate annotations for traffic features as compared to the previous systems that merely use line fitting to connect lines that are already labeled for the maps.

### BRIEF DESCRIPTION OF THE DRAWINGS

The present systems and methods for feature detection models for autonomous and/or semi-autonomous systems and applications are described in detail below with reference to the attached drawing figures, wherein:

FIG. 1A illustrates an example data flow diagram for a process of detecting features and/or annotating a map using one or more machine learning models, in accordance with some embodiments of the present disclosure;

FIG. 1B illustrates an example of an architecture of one or more machine learning models that detect features, in accordance with some embodiments of the present disclosure;

FIG. 1C illustrates examples of cross-attention layers that may be used by one or more machine learning models, in accordance with some embodiments of the present disclosure;

FIG. 1D illustrates an example of one or more machine learning models outputting information associated with points of a feature, in accordance with some embodiments of the present disclosure;

FIGS. 2A-2B illustrate an example of segmenting a map in order to generate images representing features within an environment, in accordance with some embodiments of the present disclosure;

FIG. 3 illustrates an example of determining locations of input points associated with features represented by an image, in accordance with some embodiments of the present disclosure;

FIG. 4 illustrates an example of determining points that are associated with features represented by an image, in accordance with some embodiments of the present disclosure;

FIG. 5 illustrates an example of a heatmap that indicates locations of features as represented by an image, in accordance with some embodiments of the present disclosure;

FIG. 6 illustrates an example of annotating a map to include information associated with features, in accordance with some embodiments of the present disclosure;

FIG. 7 illustrates a data flow diagram illustrating a process for training one or more machine learning models to detect features associated with images and/or maps, in accordance with some embodiments of the present disclosure;

FIG. 8 illustrates an example of one or more systems that may be configured to perform at least a portion of the processes described herein, in accordance with some embodiments of the present disclosure;

FIGS. 9-10 illustrate flow diagrams showing methods for detecting features associated with images, in accordance with some embodiments of the present disclosure;

FIG. 11A is an illustration of an example autonomous vehicle, in accordance with some embodiments of the present disclosure;

FIG. 11B is an example of camera locations and fields of view for the example autonomous vehicle of FIG. 11A, in accordance with some embodiments of the present disclosure;

FIG. 11C is a block diagram of an example system architecture for the example autonomous vehicle of FIG. 11A, in accordance with some embodiments of the present disclosure;

FIG. 11D is a system diagram for communication between cloud-based server(s) and the example autonomous vehicle of FIG. 11A, in accordance with some embodiments of the present disclosure;

FIG. 12 is a block diagram of an example computing device suitable for use in implementing some embodiments of the present disclosure; and

FIG. 13 is a block diagram of an example data center suitable for use in implementing some embodiments of the present disclosure.

### DETAILED DESCRIPTION

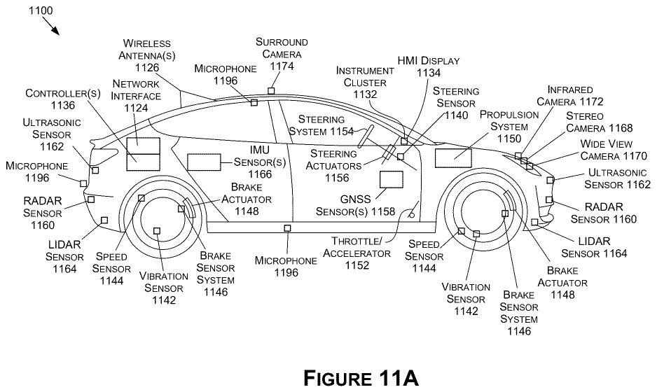

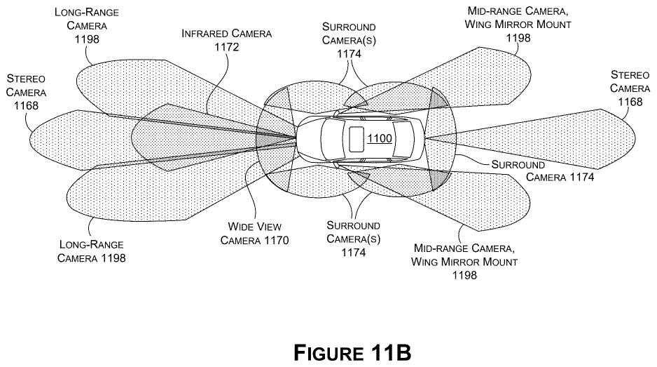

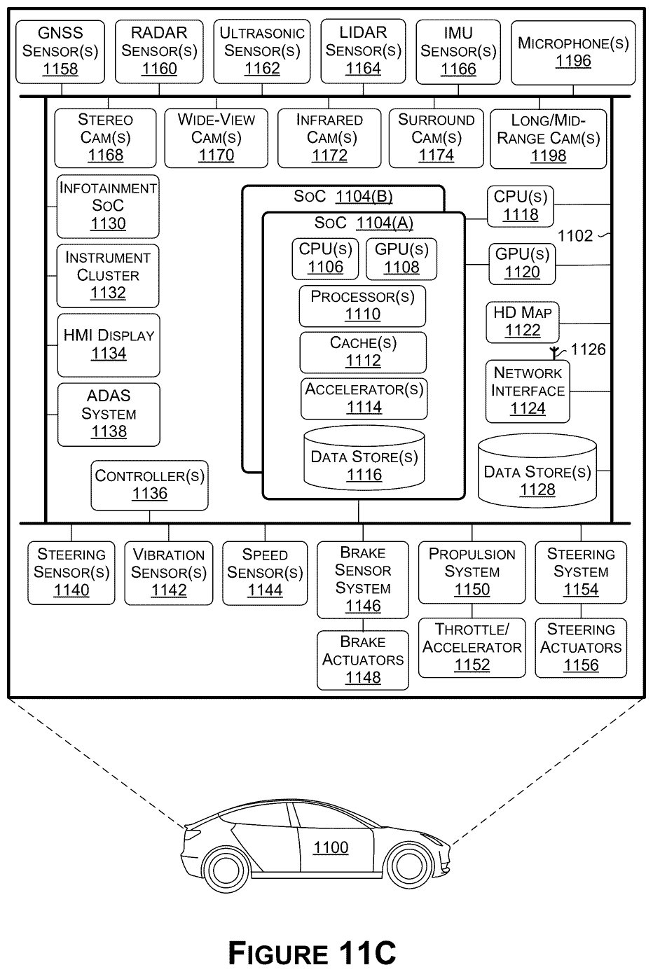

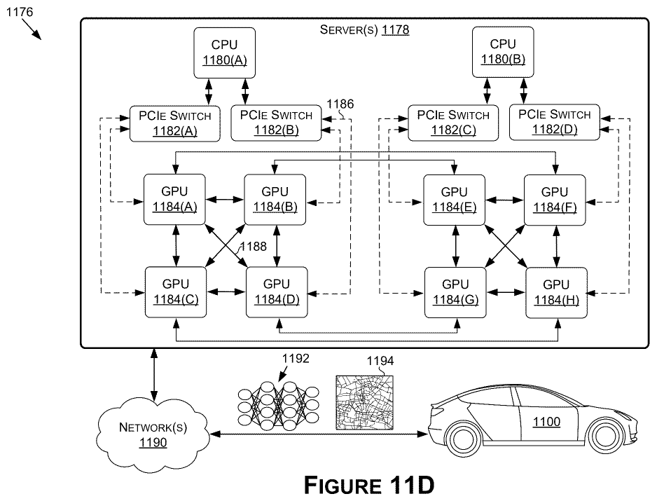

Systems and methods are disclosed related to feature detection models for autonomous and/or semi-autonomous systems and applications. Although the present disclosure may be described with respect to an example autonomous or semi-autonomous vehicle or machine 1100 (alternatively referred to herein as “vehicle 1100,” “ego-vehicle 1100,” “ego-machine 1100,” or “machine 1100,” an example of which is described with respect to FIGS. 11A-11D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to detecting traffic features and/or annotating maps with labels associated with the traffic features, this is not intended to be limiting, and the systems and methods described herein may be used in augmented reality, virtual reality, mixed reality, robotics, security and surveillance, autonomous or semi-autonomous machine applications, and/or any other technology spaces where object or feature detection and/or map creation may be used.

For instance, a system(s) may generate, receive, retrieve, obtain, and/or store map data representative of a map—such as a navigational map, a standard-definition (SD) map, a high-definition (HD) map, an occupancy map or grid, and/or any other type of map—associated with an environment. In some examples, the map may be associated with different layers corresponding to various types of sensor modalities and/or various types of features. For example, the map may be associated with one or more image layers, one or more LiDAR layers, one or more RADAR layers, one or more wait condition layers, one or more road marking layers, and/or any other type of layers. Additionally, the map may represent information associated with features located within the environment including, but not limited to, locations of the features, orientations of the features, classifications of the features, and/or any other information. As described herein, the features may include traffic features—such as road edges, road markings, lane edges, lane markings, traffic poles, traffic signs, traffic lights, and/or the like—and/or any other type of feature and/or object that may be located within the environment.

The system(s) may then perform various techniques to generate annotations for at least some of the features represented by the map. For instance, the system(s) may segment the map into portions that represent specific areas of the environment. As described herein, in some examples, the portions of the map may be represented using images—such as top-down images (e.g., bird's-eye-view images) and/or intensity images—that represent the different areas of the environment. For example, the LiDAR data (e.g., the LiDAR layer) associated with the map and/or point cloud data associated with the LiDAR data may represent intensities of points within the environment. For instance, the LiDAR sensors used to generate the LiDAR data may measure the intensities of the points at the time light returns back to the LiDAR sensors. The intensities may be represented using numbers, such as numbers that are between 0 and 256 (and/or any other range), where the numbers vary based on the composition (e.g., color, texture, material, etc.) of the surface for which the light reflected. For instance, a low number may indicate a low reflectivity while a high number may indicate a high reflectivity. In some examples, the intensities may depend on other factors, such as the angles of arrival, the ranges of the points, and/or the like.

As such, the system(s) may process the LiDAR data and/or the point cloud data to generate the images (e.g., the top-down, intensity images) associated with the map. Since the intensities of the points may vary based on one or more factors—such as the colors of the surfaces associated with the points (e.g., the colors of the surfaces for which the light reflected) - the images may indicate the structure of various features located within the environment. For example, if a feature includes a road marking that is located on a road surface within the environment, where the road marking is painted using a specific color (e.g., white, yellow, etc.), then an image of the environment may depict the points associated with the road marking as being a different color as compared to the points associated with other features, such as the road surface itself.

The system(s) may then use the images to detect the features located within the environment. For instance, and for an image, the system(s) may determine one or more points (the prompt point(s)) associated with a feature (e.g., a lane marking) as represented by the image. In some examples, the system(s) may determine the prompt point(s) using input data representing one or more inputs from one or more users that indicate the location(s) of the prompt point(s) within the image. Additionally, or alternatively, in some examples, the system(s) may process the image and/or the map to automatically determine the location(s) of the prompt point(s) within the image. For example, a portion of the feature as represented by the map may have already been annotated, such as by using one or more of the processes described herein. As such, the system(s) may use the annotations to determine the location(s) of the prompt point(s) within the image.

The system(s) may then process input data associated with the image and/or the prompt point(s) using one or more machine learning models (e.g., the model(s)) that are trained to determine information associated with the feature, such as points (e.g., the output points) and/or a representation of the feature. For example, the model(s) may include one or more encoders (the image encoder(s)) that are configured to generate one or more image embeddings associated with the image. The model(s) may also include one or more additional encoders (the prompt encoder(s)) that are configured to generate one or more tokens associated with the prompt point(s). In some examples, the prompt encoder(s) may be configured to generate a respective token associated with each of the prompt point(s). In some examples, the model(s) may append the token(s) to one or more learnable tokens to generate one or more input tokens, which is described in more detail herein. However, and as described in more detail herein, in some examples, the system(s) may not receive any prompt points associated with the image. In such examples, the input token(s) may just include the learnable token(s).

The model(s) may then include one or more cross-attention components that are configured to process the image embedding(s) and the input token(s). For instance, in some examples, the cross-attention component(s) may include one or more cross-attention layers—such as one or more two-way cross-attention layers—one or more token-image transformers, and/or any other type of processing component that is configured to perform one or more of the processes described herein. Based at least on the processing, the cross-attention component(s) may generate and/or output at least one token (e.g., the output token(s)) associated with the location(s) of the prompt point(s) and at least one token (e.g., the image token(s)) associated with the image. In some examples, the output token(s) may be associated with a vector that includes a specific dimension.

The model(s) may then process the output token(s) and/or the image token using one or more decoders that are configured to determine output points associated with the feature. In some examples, the decoder(s) may include any type of decoder, such as an autoregressive transformer decoder. Additionally, in some examples, the decoder(s) may be configured to determine a threshold number (e.g., 100) of the output points using a sequence. For example, the decoder(s) may determine a first output point using the output token(s), a second output point using a second output token associated with the first output point (and/or any other preceding output token), a third output point using a third output token associated with the second output point (and/or any other preceding output token), a fourth output point using a fourth input token associated with the third output point (and/or any other preceding output token), and/or so forth until reaching the threshold number of points.

In some examples, the decoder(s) determines the additional output tokens using a matrix (which may represent one or more learnable tokens) that includes dimensions associated with a size of the image. For example, if the size of the image is 1024*512, then the dimensions of the matrix may include 1024 units in the x-direction and 512 units in the y-direction. To determine an output token, the decoder(s) may use the matrix and the previous output point. For example, to determine the second output token in the example above, the decoder(s) may use the matrix and the first output point to determine a vector that is associated with the first output point, where the vector is associated with the second output token. Additionally, to determine the third output token, the decoder(s) may use the matrix and the second output point to determine a vector that is associated with the second output point, where that vector is associated with the third output token.

Furthermore, in some examples, the decoder(s) may be configured to determine classifications associated with the output points. As described herein, a classification may include, but is not limited to, a valid point (e.g., a point associated with the feature), an invalid point (e.g., a point not associated with the feature, which may be discarded), a joint point (e.g., a point associated with multiple features), and/or any other classification.

The model(s) may also process the image token and/or the output tokens using one or more additional layers that are configured to generate a heatmap indicating the location of the feature as represented by the image. In some examples, the additional layer(s) may include any type of layers associated with machine learning models, such as one or more convolution layers. The system(s) and/or the model(s) may then use the output points and/or the heatmap to determine a final representation associated with the feature. For example, and since the output points may be generated using a sequence, the system(s) and/or the model(s) may generate the final representation by connecting the points (e.g., the valid points and/or the joint points) according to an order at which the points were generated. Additionally, such as to improve the connecting of the points, the system(s) and/or the model(s) may use the heatmap. By performing such processes, the system(s) may generate a representation of the feature within the environment, such as a line representation of a road edge, a road marking, a lane edge, and/or a lane marking.

In some examples, the system(s) may perform similar processes to generate one or more additional representations for one or more additional features represented by the image and/or one or more additional images. Additionally, in some examples, the system(s) may perform one or more processes to determine classifications associated with the features. For instance, the system(s) may process the map, images of the features from the map (e.g., the intensity images, color images, etc.), and/or any other information associated with the features to determine the final classifications. For example, if the feature includes a road marking, then the system(s) may process the images using the model(s) (e.g., one or more additional layers of the model) and/or one or more additional machine learning models that are trained to determine whether the road marking includes a solid road marking, a dashed road marking, a double road marking, a center road marking, a two-way road marking, a passing road marking, an arrow, a stopping line, a crosswalk line, and/or any other type of road marking. Additionally, in some examples, the system(s) may then use these determinations to annotate the map, such as by labeling the map to indicate the locations and/or classifications associated with the features.

As such, by performing one or more of the processes described herein, the system(s) is able to determine final representations associated with features with no and/or little input from one or more users. For instance, such as when the system(s) just uses the learnable token(s) as the input token(s) to the model(s), the system(s) may automatically determine the final representations without needing input from one or more users. For example, if a feature includes a road marking within an environment, then the system(s) may use the learnable token(s) and the model(s) to automatically determine a line representation associated with the road marking. This provides numerous improvements over the conventional systems, which again require users to select hundreds and/or thousands of points to generate such line representations and/or merely use curve fitting to generate such line representations.

In some examples, the system(s) may train the model(s) to perform one or more of the processes described herein, such as to determine the information associated with the features. For instance, the model(s) may be trained using training input data, such as data that represents training images (e.g., top-down and/or intensity images) depicting features and/or locations of prompt points associated with the features, and corresponding ground truth data, such as data representing output points (e.g., actual points) associated with the features, heatmaps indicating the locations of the features, and/or classifications associated with the output points. One or more training engines may then be configured to determine one or more losses using outputs from the model(s), as generated based on processing the training input data, and the ground truth data. For example, the training engine(s) may determine the loss(es) based at least on comparing the outputs to the ground truth data using one or more loss functions. The training engine(s) may also be configured to update one or more parameters and/or weights associated with the model(s) using the loss(es). The training of the model(s) is described in more detail.

While the examples herein describe processing images associated with a map in order to determine information associated with features represented by the map, in other examples, similar processes may be used for other technologies. For example, a machine navigating within an environment may generate images using one or more sensors, such as one or more red-green-blue images, one or more intensity images, one or more top-down images, and/or any other types of images. The machine may then process the images using one or more of the processes described herein in order to determine information associated with features located within the environment. Additionally, the machine may perform one or more operations based at least on the information associated with the features. For instance, such as when the features include road markings, the machine may determine how to navigate within the environment based at least on the locations of the road markings within the environment.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large - the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's Tensor®), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Additionally, in some embodiments, the systems and methods described herein may be performed within a simulation environment (e.g., NVIDIA's DriveSIM) using simulated data (e.g., simulated sensor data of simulated sensors of a virtual or simulated machine). For example, simulated sensor data and/or map data (simulated or real) may be used to perform various operations within the simulation environment, such as to determine locations of features within the simulated environment. These simulated operations may be used to test performance of the underlying algorithms, systems, and/or processes prior to deploying them in the real-world. In some instances, the simulation may be used to generate synthetic training data—e.g., training data including landmarks, features, objects, etc.—so that the synthetic training data (in addition to or alternatively from real-world data) may then be processed to perform feature detection, update virtual or simulated maps, and/or perform other operations.

In any example, such as where a simulation environment is used for testing, validation, training, etc., the simulation environment and/or associated training data may be rendered or otherwise generated using one or more light transport algorithms - such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

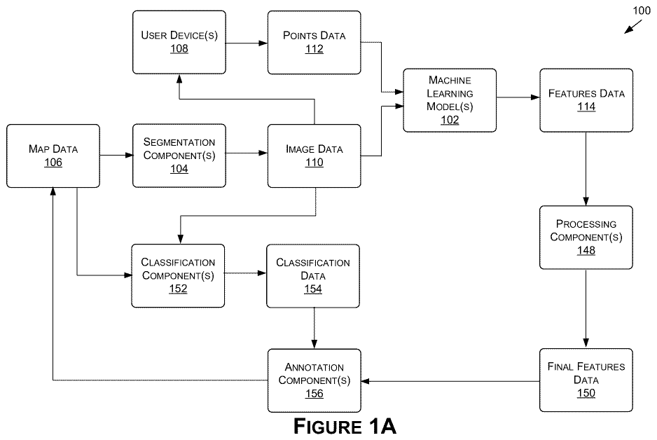

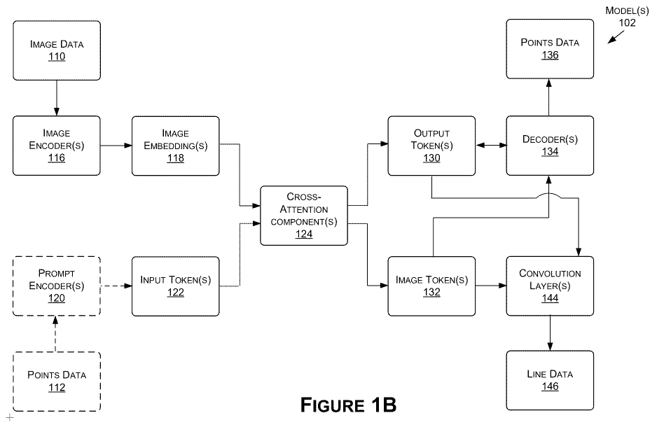

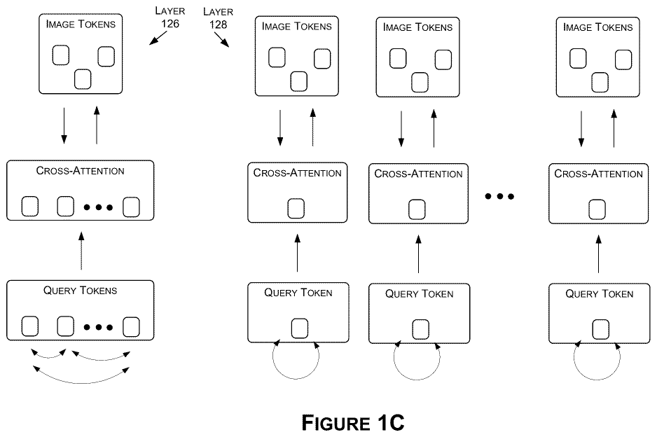

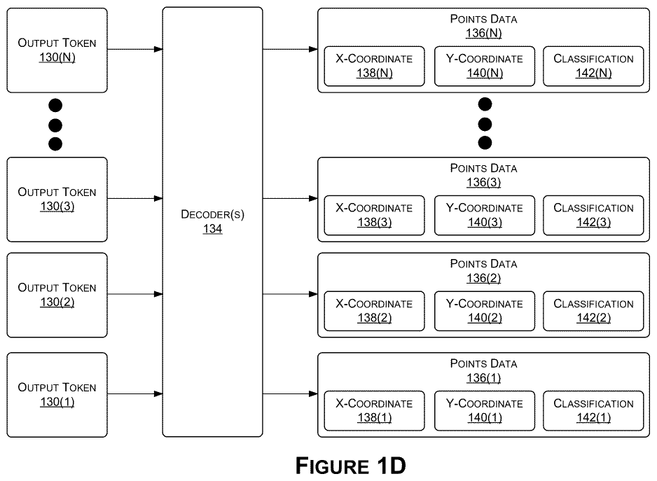

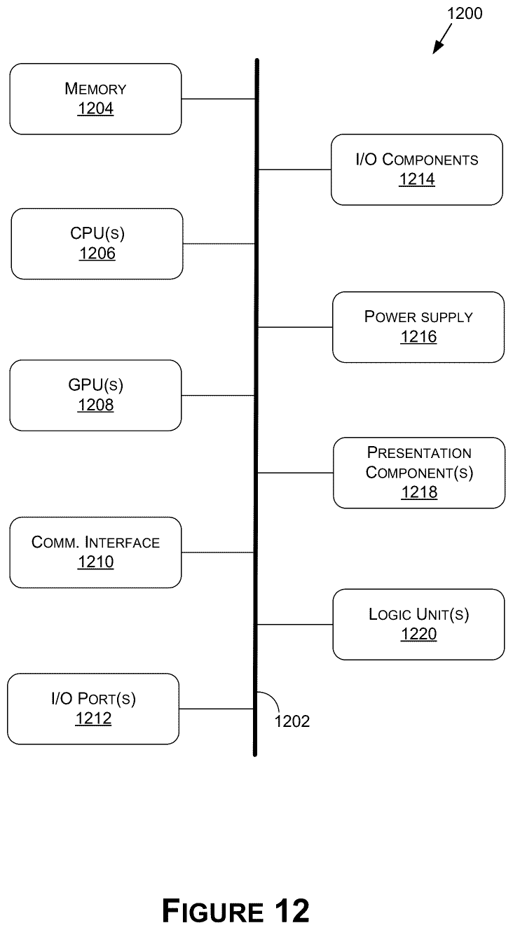

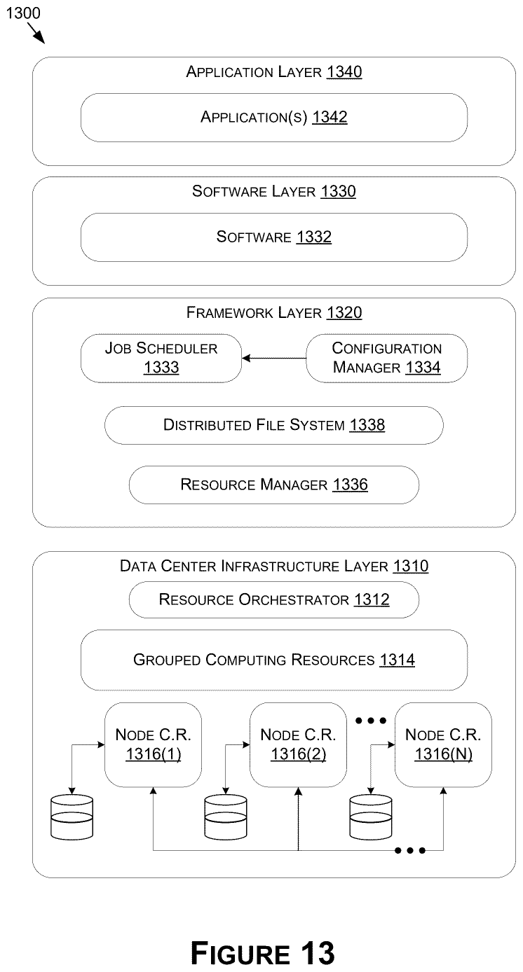

With reference to FIG. 1A, FIG. 1A illustrates an example data flow diagram for a process 100 of detecting features and/or annotating a map using one or more machine learning models 102, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1100 of FIGS. 11A-11D, example computing device 1200 of FIG. 12, and/or example data center 1300 of FIG. 13.

For instance, the process 100 may include one or more segmentation components 104 receiving map data 106 representing one or more maps. As described herein, a map may include any type of map—such as a navigational map, a SD map, a HD map, and/or any other type of map—associated with an environment. In some examples, the map may be associated with different layers corresponding to various types of sensor modalities and/or various types of features. For example, the map may be associated with one or more image layers, one or more LiDAR layers, one or more RADAR layers, one or more wait condition layers, one or more lane marking layers, and/or any other type of layer. Additionally, the map may represent information associated with features located within the environment including, but not limited to, locations of the features, orientations of the features, classifications of the features, and/or any other information. As described herein, the features may include traffic features—such as road edges, road markings, lane edges, lane markings (e.g., a type of road marking), traffic poles, traffic signs, traffic lights, and/or the like—and/or any other type of feature and/or object that may be located within the environment.

The process 100 may then include the segmentation component(s) 104 segmenting a map into portions that represent specific areas of an environment. As described herein, in some examples, the portions of the map may be represented using images—such top-down images (e.g., bird's-eye-view images) and/or intensity images—that represent different areas of the environment. For example, the LiDAR data (e.g., the LiDAR layer) associated with the map and/or point cloud data associated with the LiDAR data may represent intensities of points within the environment. For instance, the LiDAR sensors used to generate the LiDAR data may measure the intensities of the points at the time light returns back to the LiDAR sensors. The intensities may be represented using numbers, such as numbers that are between 0 and 256 (and/or any other range), where the numbers vary based on the composition (e.g., color, texture, material, etc.) of the surface for which the light reflected. For instance, a low number may indicate a low reflectivity while a high number may indicate a high reflectivity. In some examples, the intensities may depend on other factors, such as the angles of arrival, the ranges of the points, and/or the like.

As such, the segmentation component(s) 104 may process the LiDAR data and/or the point cloud data to generate the images (e.g., the top-down, intensity images) associated with the map. Since the intensities of the points may vary based on one or more factorsp—such as the colors of the surfaces associated with the points (e.g., the colors of the surfaces for which the light reflected), the images may indicate the structure of various features located within the environment. For example, if a feature includes a road marking that is located on a road within the environment, where the road marking is painted using a specific color (e.g., white, yellow, etc.), then an image of the environment may depict the points associated with the road marking as being a different color as compared to the points associated with other features, such as the road surface itself.

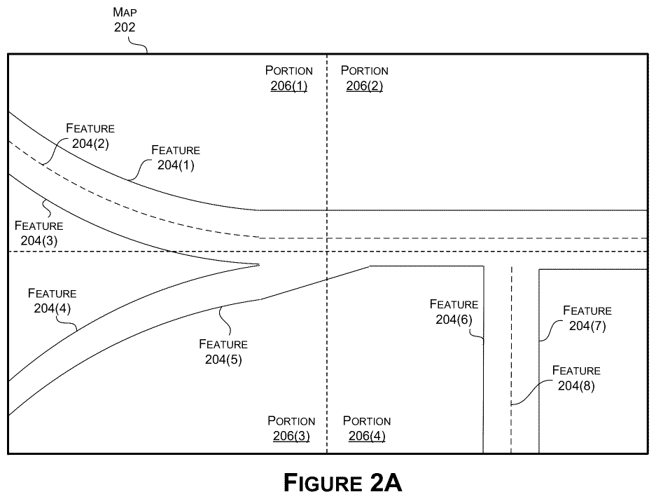

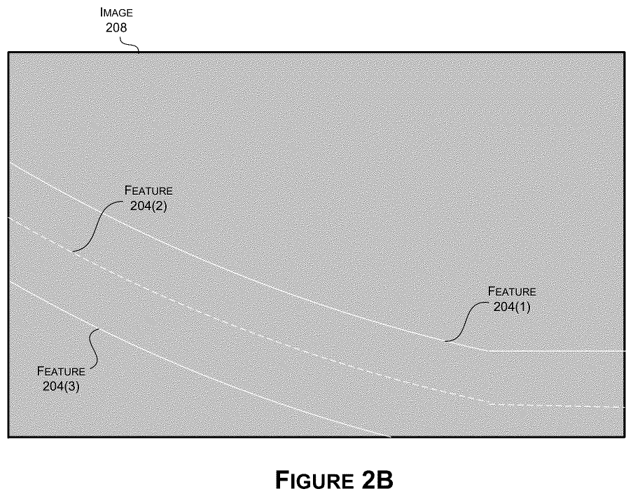

For instance, FIGS. 2A-2B illustrate an example of segmenting a map in order to generate images representing features within an environment, in accordance with some embodiments of the present disclosure. As illustrated by the example of FIG. 2A, the segmentation component(s) 104 may initially receive a map 202 of an environment, where the environment includes at least features 204(1)-(8) (also referred to singularly as “feature 204” or in plural as “features 204”). While the example of FIG. 2A illustrates the features 204 as including road and/or lane markings, in other examples, the map 202 may represent any other type of features located within the environment. The segmentation component(s) 104 may then segment the map 202 into portions 206(1)-(4) (also referred to singularly as “portion 206” or in plural as “portions 206”). While the example of FIG. 2A illustrates segmenting the map 202 into four portions 206 that do not overlap, in other examples, the segmentation component(s) 104 may segment the map 202 into any number of portions and/or one or more portions may overlap with one or more other portions.

Next, and as illustrated by the example of FIG. 2B, the segmentation component(s) 104 may generate at least an image 208 associated with the first portion 206(1) of the map 202. In the example of FIG. 2B, the image 208 may include a top-down intensity image that the segmentation component(s) 104 generates using LiDAR data and/or point cloud data associated with the map 202 and/or the environment. For example, the pixels of the image 208 may indicate intensities of points within the environment as measured by one or more LiDAR sensors when generating the LiDAR data. As such, the pixels associated with the features 204 may be associated with points that include first intensities while the pixels associated with other features (e.g., the road surface, the surrounding surface, etc.) may be associated with points that include second, lower intensities. Because of this, the features 204 within the image 208 appear brighter as compared to the surrounding environment.

While the example of FIG. 2B illustrates generating the top-down intensity image 208, in other examples, the segmentation component(s) 104 may generate any other type of image. For example, the segmentation component(s) 104 may generate a red-green-blue (RGB) image associated with the first portion 206(1) of the map 202, such as by using image data associated with the map 202 and/or the environment. Additionally, while the example of FIGS. 2A-2B illustrates generating the image 208 associated with the first portion 206(1) of the map 202, in other examples, the segmentation component(s) 104 may generate one or more additional images associated with one or more of the portions 206(2)-(4) of the map 202.

Referring back to the example of FIG. 1A, the process 100 may include one or more user devices 108 receiving image data 110 representing the images generated by the segmentation component(s) 104. Based at least on receiving the image data 110, the user device(s) 108 may present the images to one or more users that are then able to view the images and provide inputs associated with the features as represented by the images. For instance, and as described herein, the user(s) may indicate one or more locations of one or more points (referred to, in some examples, as “prompt points”) located on a respective feature as represented by an image. For example, if the feature includes a road marking, then the user(s) may indicate the location(s) of the point(s) located on the road marking. Based at least on the inputs, the process 100 may include the user device(s) 108 generating and/or outputting points data 112 representing the points input by the user(s).

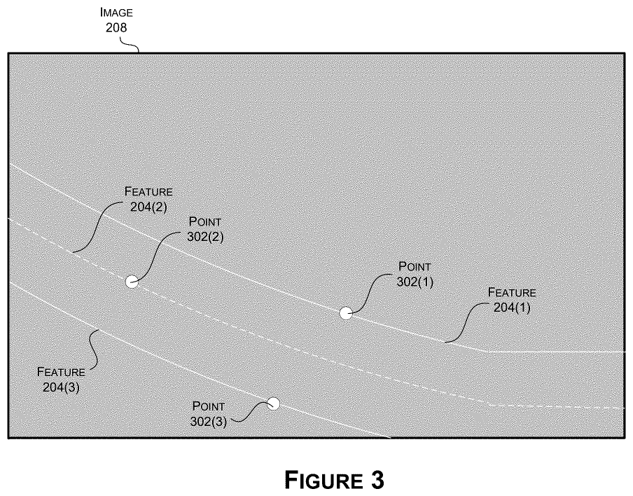

For instance, FIG. 3 illustrates an example of determining locations of prompt points 302(1)-(3) (also referred to singularly as “prompt point 302” or in plural as “prompt points 302”) associated with features 204 represented by the image 208, in accordance with some embodiments of the present disclosure. As shown, the prompt points 302 include at least the first prompt point 302(1) located on the first feature 204(1), the second prompt point 302(2) located on the second feature 204(2), and the third prompt point 302(3) located on the third feature 204(3). While the example of FIG. 3 illustrates only one prompt point 302 for each of the features 204, in other examples, any number of prompt points may be indicated for each feature 204.

Referring back to the example of FIG. 1A, the process 100 may include applying input data associated with the images, as represented by the image data 110, and the prompt points, as represent by the points data 112, into the model(s) 102. Based at least on the model(s) 102 processing the input data, the process 100 may include the model(s) 102 generating and/or outputting features data 114 representing information associated with the features as represented by the images. As described herein, in some examples, the information may include, but is not limited to, output points associated with the features, heatmaps indicating locations of the features as represented by the images, and/or representations (e.g., lines) that represent the locations of the features within the map.

For more details, FIG. 1B illustrates an example of an architecture of the model(s) 102 that detects features, in accordance with some embodiments of the present disclosure. As shown, the model(s) 102 may include one or more image encoders 116 that are configured to process the image data 110 (e.g., a top-down and/or intensity image) in order to generate one or more image embeddings 118 associated with the image. As described herein, the image encoder(s) 116 may include any type of encoder that is trained to generate the image embedding(s) 118 associated with the image, such as a Vision Transformer. Additionally, a size of the image embedding(s) 118 may be based on a size of the image.

The model(s) 102 may further include one or more prompt encoders 120 that are configured to process the points data 112 (e.g., the prompt point(s)) in order to generate one or more input tokens 122 (e.g., input prompt tokens) associated with the prompt point(s). As described herein, the prompt encoder(s) 120 may include any type of encoder that is trained to generate the input prompt token(s) 122 associated with the prompt point(s). Additionally, an input prompt token 122 may represent a positional encoding associated with a prompt point. As such, the number of input prompt tokens 122 generated by the prompt encoder(s) 120 may depend on the number of prompt points represented by the points data 112. For example, the prompt encoder(s) 120 may generate a respective input prompt token 122 for one or more (e.g., each) of the prompt point(s).

Additionally, in some examples, at least one of the input token(s) 122 may further include a learnable token from training the model(s) 102. As such, the model(s) 102 may append (e.g., concatenate, etc.) the input prompt token(s) 122 associated with the prompt point(s) with the learnable input token(s) 122 in order to generate the actual token(s) 122 that is further processed by the model(s) 102. In some examples, a learnable input token 122 may help improve the performance of the model(s) 102 since the learning input token 122 may be unrelated to the image (e.g., avoid bias towards the image) and/or perform global context aggregation from the image features.

While this example describes the input token(s) 122 as including both the input prompt token(s) 122 and the learnable input token(s) 122, in other examples (and as indicated by the dashed lines showing optional data and/or components), the input token(s) 122 may include the learnable input token(s) 122 without the input prompt token(s) 122. For example, the input token(s) 122 may include a set of learnable tokens that are learned by the model(s) 102 during training. In such examples, the model(s) 102 may then not receive the points data 112 and/or include the prompt encoder(s) 120 that is configured to generate the input prompt token(s) 122. In other words, the model(s) 102 may be configured to perform one or more of the processes described herein without receiving any input from the user(s).

In such examples, the number of learnable tokens 122 may depend on one or more factors, such as a number of features that may be represented by images. For example, the number of learnable tokens 122 may be equal to or greater than a maximum number of possible features as represented by images. This is because, in some examples, a single learnable token 122 may be used to query a single feature as represented by an image. As such, a respective learnable token 122 may be needed for each of the features.

The model(s) 102 may further include one or more cross-attention components 124 that are configured to process the image embedding(s) 118 and the input token(s) 122. As described herein, the cross-attention component(s) 124 may include one or more cross-attention layers—such as one or more two-way cross-attention layers—one or more token-image transformers, and/or any other type of processing component that is configured to perform one or more of the processes described herein. For example, based at least on the processing, the cross-attention component(s) 124 may be configured to compare the text features associated with the prompt point(s) to the image features associated with the image in order to learn relationships between the text features and the image features. As such, in some examples, the dimensions associated with the image embedding(s) 118 may be similar to the dimensions associated with the input token(s) 122.

For more details, FIG. 1C illustrates examples of cross-attention layers that may be used by one or more machine learning models, in accordance with some embodiments of the present disclosure. As shown, the cross-attention component(s) 124 may include one or more cross-attention layers 126 and/or one or more cross-attention layers 128. For example, the cross-attention component(s) 124 may include two of the cross-attention layers 126 (and/or any other number of the cross-attention layers 126) followed by four of the cross-attention layers 128 (and/or any other number of the cross-attention layers 128). As shown, the cross-attention layer(s) 126 may perform pairwise self-attention between query tokens and two-way cross-attention between the set of query tokens and image tokens. Next, the cross-attention layer(s) 128 may independently perform self-attention of a query token and two-way cross-attention between the query token and a copy of the image tokens. As such, the cross-attention layer(s) 126 may share all the query tokens and the same image features while the cross-attention layer(s) 128 may include an updated image token for each query token. More specifically, in some examples, each query token of the cross-attention layer(s) 128 may independently conduct cross-attention with the image tokens while all of the query tokens of the cross-attention layer(s) 126 may conduct cross-attention with the image tokens.

In some examples, the cross-attention layer(s) 126 and/or the cross-attention layer(s) 128 may be associated with one or more of the examples described herein. For example, the cross-attention layer(s) 126 and/or the cross-attention layer(s) 128 may be used when the model(s) 102 is able to automatically perform one or more of the processes described herein, such as without using the points data 112 (e.g., the model(s) 102 just uses the learnable tokens). In other words, the cross-attention layer(s) 126 and/or the cross-attention layer(s) 128 may help the model(s) 102 generate representations for features without user input.

Referring back to the example of FIG. 1B, the model(s) 102 may include the cross-attention component(s) 124 generating and/or outputting one or more output tokens 130 and/or one or more image tokens 132. As described herein, the output token(s) 130 may be associated with the positional information corresponding to the prompt point(s) represented by the points data 112. Additionally, in some examples, the cross-attention component(s) 124 may be configured to generate and/or output a single output token 130 associated with each feature. For example, even if the points data 112 represents multiple prompt points for a feature such that the prompt encoder(s) 120 generates multiple input tokens 122, the cross-attention component(s) 124 may still be configured to generate the single output token 130 that represents the positional information associated with the prompt points.

The model(s) 102 may further include one or more decoders 134 that are configured to process the output token(s) 130 and/or the image token(s) 132 in order to generate and/or output points data 136 representing one or more points associated with a feature. As described herein, in some examples, the points data 136 may represent a given number of points for which the decoder(s) 134 is configured and/or trained to output, such as 100 points (and/or any other number of points). Additionally, the points data 136 may represent the points using coordinates, such as x-coordinate locations and y-coordinate locations associated with the image and/or the map, and/or represent the points using a sequence. Furthermore, in some examples, the points data 136 may represent additional information associated with the points, such as classifications associated with the points. As described herein, a classification may include, but is not limited to, a valid point (e.g., a point associated with the feature), an invalid point (e.g., a point not associated with the feature, which may be discarded), a joint point (e.g., a point associated with multiple features), and/or any other type of classification.

For more details, FIG. 1D illustrates an example of the model(s) 102 outputting information associated with points of a feature, in accordance with some embodiments of the present disclosure. In the example FIG. 1D, the decoder(s) 134 may initially process the first output token 130(1) that is generated by the cross-attention component(s) 124 (and, in some examples, the image token(s) 132) in order to generate the first points data 136(1) representing a first point associated with the feature. As shown, the first point may be associated with a first x-coordinate location 138(1), a first y-coordinate location 140(1), and a first classification 142(1). The decoder(s) 134 may then process the second output token 130(2) that corresponds to the first point (and, in some examples, the image token(s) 132 and/or the first output token 130(1)) in order to generate the second points data 136(2) representing a second point associated with the feature. As shown, the second point may be associated with a second x-coordinate location 138(2), a second y-coordinate location 140(2), and a second classification 142(2).

The decoder(s) 134 may then process the third output token 130(3) that corresponds to the second point (and, in some examples, the image token(s) 132 and/or the output tokens 130(1)-(2)) in order to generate the third points data 136(3) representing a third point associated with the feature. As shown, the third point may be associated with a third x-coordinate location 138(3), a third y-coordinate location 140(3), and a third classification 142(3). The decoder(s) 134 may then continue to perform these processes until the decoder(s) 134 processes the final output token 130(N) that corresponds to the second to last point (and, in some examples, the image token(s) 132 and/or any other preceding output tokens) in order to generate the final points data 136(N) representing a final point associated with the feature. As shown, the final point may be associated with a final x-coordinate location 138(N), a final y-coordinate location 140(N), and a final classification 142(N).

As described herein, the decoder(s) 134 may be configured to generate the points data 136 representing the given number of points, such as 100 points (and/or any other number of points). However, only a portion of the points may actually be associated with the feature, such as 40 points (and/or any other number of points). As such, the classifications 142(1)-(N) (also referred to singularly as “classification 142” or in plural as “classifications 142”) may indicate which of the points is associated with the feature and which of the points is not associated with the feature. For example, the points that are associated with the valid point classification and/or the joint point classification may be associated with the feature while the points associated with the invalid point classification may not be associated with the feature (e.g., the points may be discarded).

Additionally, as shown, the decoder(s) 134 may output the points in a sequence that includes the first point, followed by the second point, followed by the third point, and so forth until the final point. As such, in some examples, the points being output may continue to be associated with the valid classification and/or the joint classification until reaching a point that is associated with the invalid classification. At that instance, the rest of the points may then be associated with the invalid classification such that those points are not associated with the feature and/or discarded. As described in more detail herein, the sequence at which the points are output may be used to generate a final representation associated with the feature.

While the example of FIG. 1D illustrates outputting a single x-coordinate location 138(1)-(N) and a single y-coordinate location 140(1)-(N) for each point, in other examples, the decoder(s) 134 may output numerous x-coordinate locations and/or numerous y-coordinate locations based at least on a size of the input image. For instance, and for a point, the decoder(s) 134 may initially determine a first number of x-coordinate locations that is based on a size of the input image in the x-coordinate direction and a second number of y-coordinate locations that is based on a size of the input image in the y-coordinate direction. For example, if the input image includes a size of 1024*512, then the decoder(s) 134 may determine that there are 1024 classes in the x-coordinate direction (e.g., one class per pixel) and 512 classes in the y-coordinate direction (e.g., one class per pixel). The decoder(s) 134 (and/or another processing component) may then use the classifications to determine the final location associated with the point.

For example, the decoder(s) 134 may select a threshold number of the highest x-coordinate class results and a threshold number of the highest y-coordinate class results. As described herein, the threshold number may include any number, such as three results for the x-coordinate classes and three results for the y-coordinate classes. Additionally, highest coordinate classes may include the classes that are associated with the highest probabilities among the classes. The decoder(s) 134 may then determine a number of candidate locations using at least the highest x-coordinate classes and the highest y-coordinate classes. For example, if the decoder(s) 134 determines the three highest x-coordinate classes and the three highest y-coordinate classes, then the decoder(s) 134 may determine nine candidate locations. Using the candidate locations, the decoder(s) 134 then determines the final location associated with the point as including the candidate location that is associated with the highest overall probability. The decoder(s) 134 may then perform similar processes for one or more (e.g., each) of the other points associated with the feature.

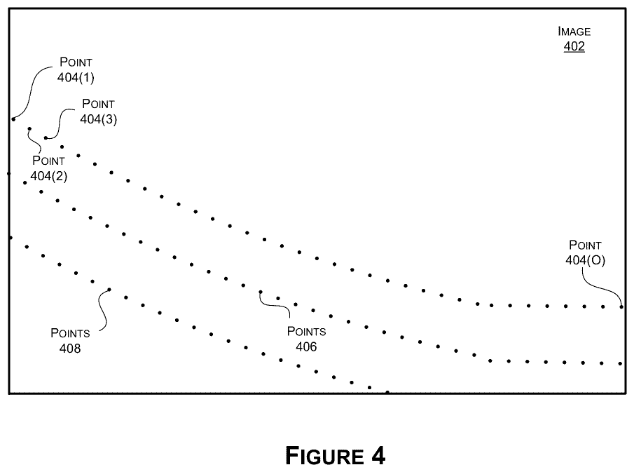

For a representation of the points, FIG. 4 illustrates an example of determining points that are associated with features represented by an image 208, in accordance with some embodiments of the present disclosure. In the example of FIG. 4, the image 402 may correspond to the image 208, such as including a RGB image 402 associated with the portion 206(1) of the map 202. As shown, and for the feature 204(1), the decoder(s) 134 may determine a sequence of points 404(1)-(O) that includes the first point 404(1), followed by the second point 404(2), followed by the third point 404(3), and/or so forth (although not all labeled for clarity reasons) until the final point 404(O) (e.g., the last valid point and/or joint point). The decoder(s) 134 may then perform similar processes to determine points 406 (although only one is labeled for clarity reasons) associated with the second feature 204(2) and points 408 (although only one is labeled for clarity reasons) associated with the third feature 204(3).

Referring back to the example of FIG. 1B, the model(s) 102 may include one or more convolution layers 144 that are configured to process the output token(s) 130 and/or the image token(s) 132 in order to generate and/or output line data 146 representing a line associated with a feature. As described herein, in some examples, the line data 146 may represent a heatmap that indicates the location of the feature as represented by the image. For example, if the feature includes a road marking, then the heatmap may indicate a line that represents the location of the road marking within the image. However, in other examples, the line data 146 may represent any other type of representation associated with the feature, such as a color image and/or an intensity image that indicates the location of the feature as associated with the input image. Additionally, in other examples, other types of layers of the model(s) 102 may be used to generate the line data 146.

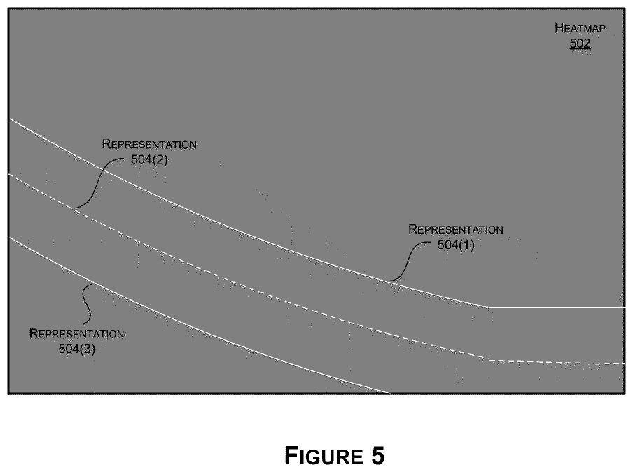

For instance, FIG. 5 illustrates an example of a heatmap 502 that indicates locations of the features 204(1)-(3) as represented by the image 208, in accordance with some embodiments of the present disclosure. As shown, the convolution layer(s) 144 may generate the heatmap 502 that includes at least a first representation 504(1) indicating the location of the first feature 204(1) within the image 208, a second representation 504(2) indicating the location of the second feature 204(2) within the image 208, and a third representation 504(3) indicating the location of the third feature 204(3) within the image 208. In the example of FIG. 5, the representations 504(1)-(3) may include lines since the features 204(1)-(3) include road markings located within the environment. However, in other examples, representations for other types of features may include any other shapes that best represent the features as depicted in images.

Referring back to the example of FIG. 1A, and as described above for a feature, the features data 114 may represent the points data 136 representing the points associated with the feature as represented by the input image and/or the line data 146 representing the heatmap of the feature. As such, the process 100 may include one or more processing components 148 (which, in some examples, may be part of the model(s) 102, such as one or more additional layers) that are configured to process the features data 114 in order to determine a final representation associated with the feature. For example, if the feature includes a road marking, then the processing component(s) 148 may be configured to determine a final line that represents the road marking using at least the points associated with the road marking and the heatmap associated with the road marking.

For example, since the decoder(s) 134 may be configured to determine the points in sequence, the processing component(s) 148 may be configured to at least connect the points in an order that is associated with the sequence. Additionally, the processing component(s) 148 may be configured to connect specific points, such as points that are classified as being valid points or points that are classified as being joint points. Furthermore, in some examples, the processing component(s) 148 may use the heatmap to better connect the points. The processing component(s) 148 may then be configured to generate and/or output final features data 150 representing the final representation(s) of the feature(s) as represented by the input image.

In some examples, and as further illustrated by the example of FIG. 1A, the process 100 may include one or more classification components 152 processing at least a portion of the map data 106 and/or the image data 110 in order to generate classification data 154 representing classifications associated with features. As described herein, the classification component(s) 152 may include and/or use one or more machine learning models, one or more neural networks, one or more algorithms, one or more classifiers, one or more modules, and/or any other type of processing component to determine the classifications associated with the features. Additionally, a classification associated with a feature may indicate at least a type associated with the feature. For example, if a feature includes a road marking, then the classification may include a solid road marking, a dashed road marking, a double road marking, a center road marking, a two-way road marking, a passing road marking, an arrow, a stopping line, a crosswalk line, and/or any other type of road marking that may be located within the environment.

While the example of FIG. 1A illustrates the classification component(s) 152 as being separate from the model(s) 102, in other examples, the classification component(s) 152 may include at least a portion of the model(s) 102. For example, the classification component(s) 152 may include one or more layers of the model(s) 102 such that the model(s) 102 is further trained to generate the classification data 154 representing the classifications associated with the features.

In some examples, the process 100 may include one or more annotation components 156 using at least a portion of the final features data 150 and/or at least a portion of the classification data 154 to annotate the map represented by the map data 106. For instance, the annotation component(s) 156 may annotate the map to include at least labels for the locations of the features, the classifications associated with the features, and/or any other information associated with the features. As such, by performing the process 100, the map may automatically be annotated with no and/or little input from one or more users.

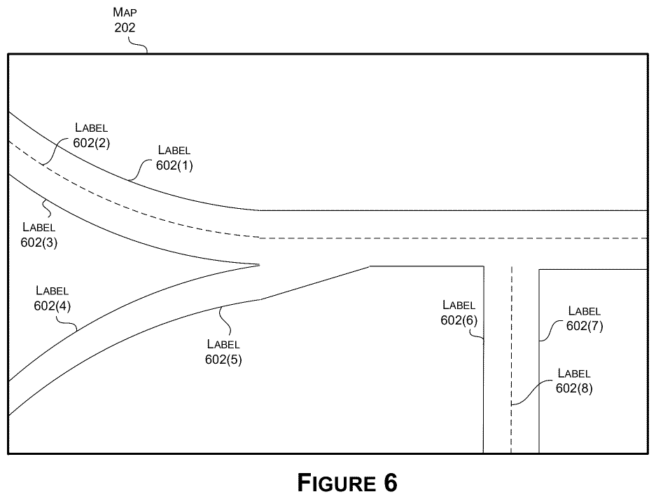

For instance, FIG. 6 illustrates an example of annotating the map 202 to include information associated with the features 204, in accordance with some embodiments of the present disclosure. As shown, the annotation component(s) 156 may use final features data representing the locations of the features 204 and/or classification data representing the classifications associated with the features 204 to annotate the map 202. For example, the annotation component(s) 156 may annotate the map 202 to include at least respective labels 602(1)-(8) (also referred to singularly as “label 602” or in plural as “labels 602”) associated with the features 204. As described herein, the labels 602 may indicate at least the locations of the features 204 and/or the classifications associated with the features 204.

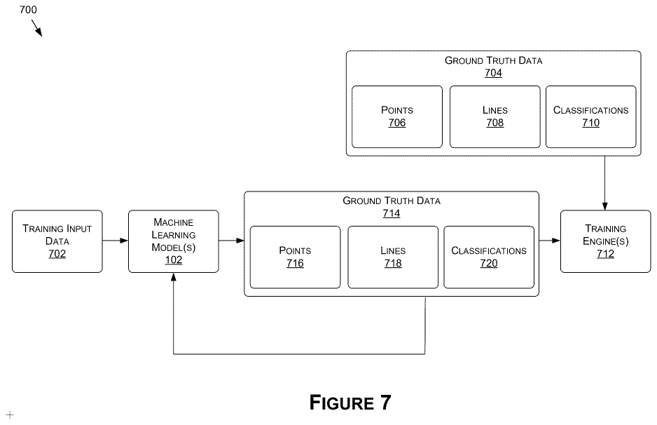

In some examples, the model(s) 102 may be trained to perform one or more of the processes described herein. For instance, FIG. 7 illustrates a data flow diagram illustrating a process 700 for training the model(s) 102 to detect features associated with images and/or maps, in accordance with some embodiments of the present disclosure. As shown, the model(s) 102 may be trained using training input data 702. In some examples, the training input data 702 may include image data, points data, image embeddings, and/or input tokens. For example, the training input data 702 may be similar to and/or include the image data 110, the points data 112, the image embeddings 118, and/or the input tokens 122.

The model(s) 102 may be trained using the training input data 702 along with corresponding ground truth data 704. As shown, the ground truth data 704 may represent at least points 706 associated with features, line representations 708 associated with the features, and/or classifications 710 associated with the features from the training input data. For instance, in some examples, the points 706 may indicate the coordinate locations associated with the points as located on the features. Additionally, in some examples, the line representations 708 may include masks and/or heatmaps indicating the locations of the features. Furthermore, in some examples, the classifications 710 may indicate whether the points 706 include valid points, invalid points, joint points, and/or any other classifications of points. As described herein, the ground truth data 704 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof. In some examples, for each instance of the training input data 702, there may be corresponding ground truth data 704.

As further illustrated in FIG. 7, one or more training engines 712 may use one or more loss functions that measure loss (e.g., error) in outputs 714 as compared to the ground truth data 704. As shown, the outputs 714 may also include predicted points 716, predicted line representations 718, and/or predicted classifications 720. Any type of loss function may be used, such as cross entropy loss, mean squared error, mean absolute error, mean bias error, line segmentation loss, and/or other loss function types. In some examples, different outputs 714 may have different loss functions. For example, the predicted points 716 may include a first loss function, the predicted line representations 718 may include a second loss function, and/or the predicted classifications 720 may include a third loss function. In such examples, the loss functions may be combined to form a total loss, and the total loss may be used to train (e.g., update the parameters of) the model(s) 102. In any example, backward pass computations may be performed to recursively compute gradients of the loss function(s) with respect to training parameters. In some examples, weights and biases of the model(s) 102 may be used to compute these gradients.

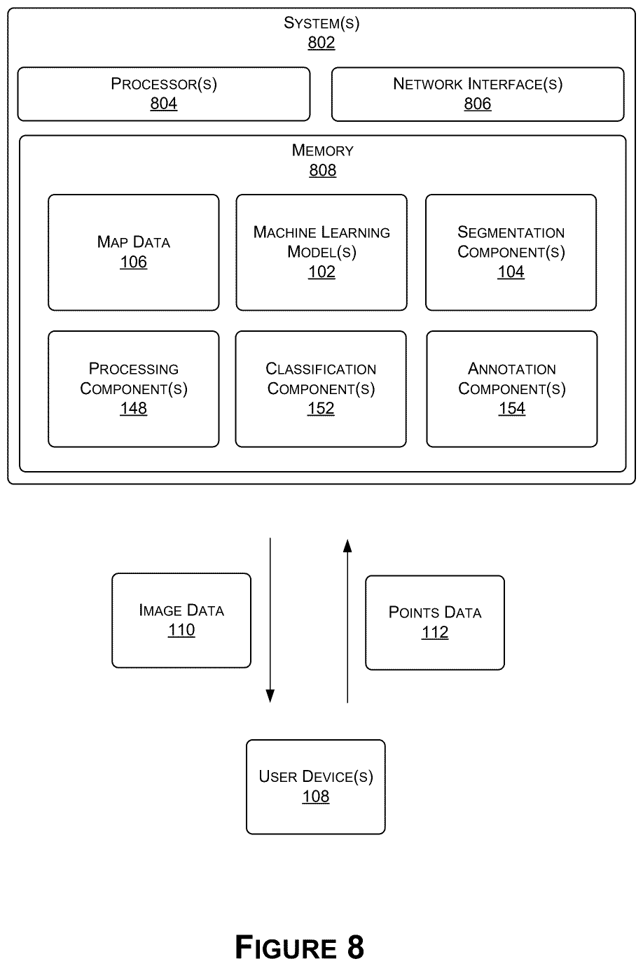

FIG. 8 illustrates an example of one or more systems 802 that may be configured to perform at least a portion of the processes described herein, in accordance with some embodiments of the present disclosure. As shown, the system(s) 802 may include at least one or more processors 804, one or more network interfaces 806, and memory 808. In some examples, the processor(s) 804 may include, and/or be similar to, a CPU(s) 1118, a GPU(s) 1120, a CPU(s) 1206, and/or a GPU(s) 1208. Additionally, the network interface(s) 806 may include, and/or be similar to, a network interface(s) 1124 and/or a communication interface(s) 1210. Furthermore, the memory 808 may include, and/or be similar to, a memory 1204.

The memory 808 may store the model(s) 102, the map data 106, the segmentation component(s) 104, the processing component(s) 148, the classification component(s) 152, and/or the annotation component(s) 156. Additionally, the processor(s) 804 may be configured to execute the model(s) 102, the segmentation component(s) 104, the processing component(s) 148, the classification component(s) 152, and/or the annotation component(s) 156 to perform one or more of the processes described herein.

As further illustrated by the example of FIG. 8, the system(s) 802 may communicate with the user device(s) 108. For example, the system(s) 802 may at least send the image data 110 to the user device(s) 108 so that the user device(s) 108 may present the images to the user(s). After receiving the user inputs, the user device(s) 108 may then send the points data 112 back to the system(s) 802. In other words, the system(s) 802 may communicate with the user device(s) 108 to at least determine the initial prompt points associated with performing the process 100 of FIG. 1A.

In some examples, the model(s) 102 may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine. ” For example, the inference microservice may include the container itself and the model (e.g., weights and biases). In some instances, such as where the model(s) 102 is small enough (e.g., has a small enough number of parameters), the model may be included within the container itself. In some embodiments, the model(s) 102 described herein may be deployed as an inference microservice to accelerate deployment of models on any cloud, data center, or edge computing system, while ensuring the data is secure. For example, the inference microservice may include one or more APIs, a preconfigured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The model(s) 102 described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the model(s) 102 and provide outputs/responses to inputs (e.g., user queries, prompts, etc.), and enterprise management software to provide health checks, identity, and other monitoring. In some embodiments, the inference microservice may include software to perform in-place replacement and/or updating to the model(s) 102. When replacing or updating, the software that performs the replacement/updating may maintain user configurations of the inference runtime software and enterprise management software.

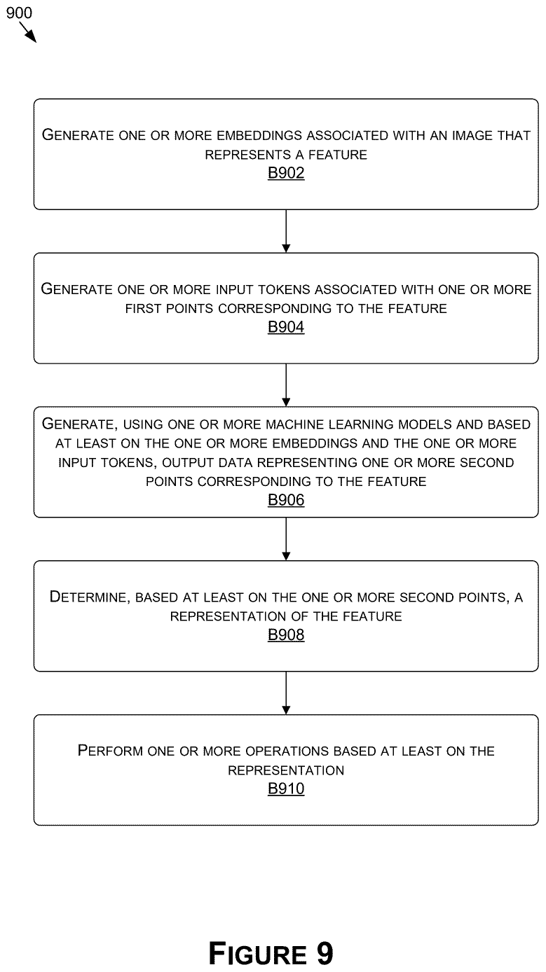

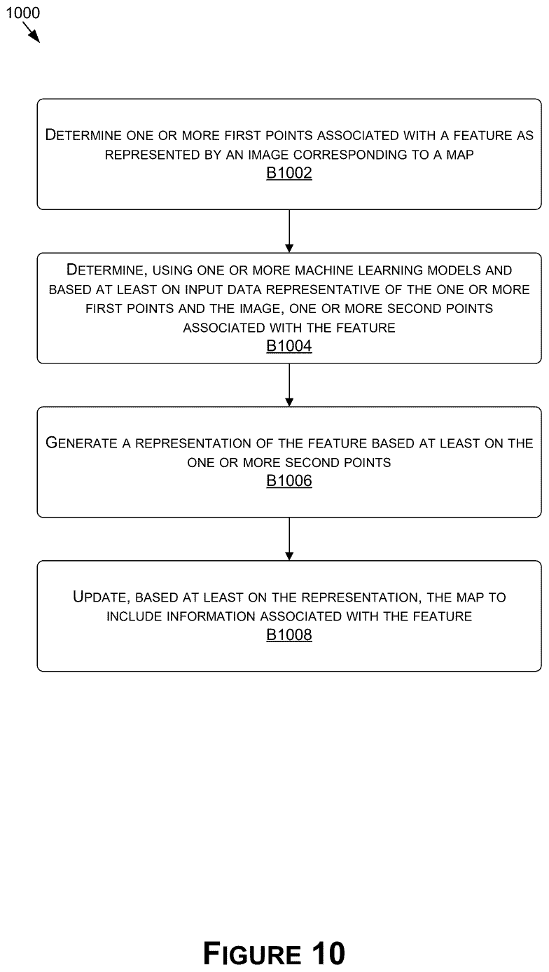

Now referring to FIGS. 9 and 10, each block of methods 900 and 1000, described herein, comprises a computing process that may be performed using any combination of hardware, firmware, and/or software. For instance, various functions may be carried out by a processor executing instructions stored in memory. The methods 900 and 1000 may also be embodied as computer-usable instructions stored on computer storage media. The methods 900 and 1000 may be provided by a standalone application, a service or hosted service (standalone or in combination with another hosted service), or a plug-in to another product, to name a few. In addition, these methods 900 and 1000 described, by way of example, with respect to FIGS. 1A-1C. However, these methods 900 and 1000 may additionally or alternatively be executed by any one system, or any combination of systems, including, but not limited to, those described herein.

FIG. 9 illustrates a flow diagram showing a method 900 for detecting features associated with images, in accordance with some embodiments of the present disclosure. The method, at block B902, may include generating one or more embeddings associated with an image that represents a feature. For instance, the image encoder(s) 116 may process the image data 110 representing the image in order to generate the image embedding(s) 118 associated with the image. As described herein, in some examples, the image may include a portion of a map that is being annotated to include information about features. However, in other examples, the image may include any other image, such as an image generated using a machine navigating within an environment.

The method 900, at block B904, may include generating one or more input tokens associated with one or more points corresponding to the feature. For instance, the input token(s) 122 associated with the feature as represented by the image may be generated, where the input token(s) 122 is associated with the first point(s). As described herein, in some examples, the prompt encoder(s) 120 may generate at least a portion of the input token(s) 122 using the points data 112 representing the location(s) of the first point(s) within the image. Additionally, in some examples, at least a portion of the input token(s) 122 may include one or more learnable tokens that are learned during training of the model(s) 102. In examples where the tokens 122 include both the input prompt token(s) 122 and the learnable token(s) 122, the input prompt token(s) 122 may be appended to the learnable token(s) 122.

The method 900, at block B906, may include generating, using one or more machine learning models and based at least on the one or more embeddings and the one or more input tokens, output data representing one or more second points corresponding to the feature. For instance, the cross-attention component(s) 124 may initially process the image embedding(s) 118 and the input token(s) 122 in order to generate at least the output token(s) 130 and the image token(s) 132. The decoder(s) 134 may then process the output token(s) 130 and/or the image token(s) 132 in order to generate the points data 136 representing the second point(s) associated with the feature. In some examples, the convolution layer(s) 144 may further process the output token(s) 130 and/or the image token(s) 132 in order to generate the line data 146 representing the heatmap of the feature.

The method 900, at block B908, may include determining, based at least on the one or more second points, a representation of the feature. For instance, the processing component(s) 148 may process the points data 136 and/or the line data 146 (e.g., the features data 114) to generate the final features data 150 representing the representation of the feature. For example, the processing component(s) 148 may generate the representation by at least connecting the second point(s) according to an order that is based on the sequence for which the decoder(s) 134 determined the second point(s). As described herein, in some examples, if the feature includes a road marking, then the representation may include a line representation of the road marking.

The method 900, at block B910, may include performing one or more operations based at least on the representation. For instance, in some examples, the annotation component(s) 156 may use at least the final features data 150 to annotate the map to indicate information associated with the feature (e.g., the location of the feature, the classification of the feature, etc.). However, in other examples, one or more additional and/or alternative processes may be performed, such as causing a machine to navigate based at least on the representation and/or location of the feature.

FIG. 10 illustrates a flow diagram showing another method 1000 for detecting features associated with images, in accordance with some embodiments of the present disclosure. The method 1000, at block B1002, may include determining one or more first points associated with a feature as represented by an image corresponding to a map. For instance, the first point(s) associated with the feature as represented by the image may be determined. As described herein, in some examples, the first point(s) may be determined based at least on one or more user inputs indicating the first point(s). Additionally, or alternatively, in some examples, the first point(s) may automatically be determined using one or more learnable tokens 122.

The method 1000, at block B1004, may include determining, using one or more machine learning models and based at least on input data associated with the one or more first points and the image, one or more second points associated with the feature. For instance, the model(s) 102 may process the input data representing the first point(s) and the image. In some examples, the processing may include generating the input token(s) 122 using the first point(s), generating the image embedding(s) 118 using the image, generating the output token(s) 130 and/or the image token(s) 132 using the cross-attention component(s) 124, and then generating the points data 136 representing the second point(s) using the decoder(s) 134.

The method 1000, at block B1006, may include generating a representation of the feature based at least on the one or more second points. For instance, the processing component(s) 148 may process the points data 136 (e.g., the features data 114) to generate the final features data 150 representing the representation of the feature. For example, the processing component(s) 148 may generate the representation by at least connecting the second point(s) according to an order that is based on the sequence for which the second point(s) was determined. As described herein, in some examples, if the feature includes a road marking, then the representation may include a line representation of the road marking.

The method 1000, at block B1008, may include updating, based at least on the representation, the map to include information associated with the feature. For instance, the annotation component(s) 156 may update the map to include the information associated with the feature. As described herein, in some examples, the information may include at least the location of the feature, the classification of the feature, and/or any other information associated with the feature.

### Example Autonomous Vehicle

FIG. 11A is an illustration of an example autonomous vehicle 1100, in accordance with some embodiments of the present disclosure. The autonomous vehicle 1100 (alternatively referred to herein as the “vehicle 1100”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1100 may be capable of functionality in accordance with one or more of Level 3-Level 5 of the autonomous driving levels. The vehicle 1100 may be capable of functionality in accordance with one or more of Level 1-Level 5 of the autonomous driving levels. For example, the vehicle 1100 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1100 or other machine, such as being fully autonomous, being highly autonomous, being conditionally autonomous, being partially autonomous, providing assistive autonomy, being semi-autonomous, being primarily autonomous, or other designation.

The vehicle 1100 may include components such as a chassis, a vehicle body, wheels (e.g., 2, 4, 6, 8, 18, etc.), tires, axles, and other components of a vehicle. The vehicle 1100 may include a propulsion system 1150, such as an internal combustion engine, hybrid electric power plant, an all-electric engine, and/or another propulsion system type. The propulsion system 1150 may be connected to a drive train of the vehicle 1100, which may include a transmission, to enable the propulsion of the vehicle 1100. The propulsion system 1150 may be controlled in response to receiving signals from the throttle/accelerator 1152.

A steering system 1154, which may include a steering wheel, may be used to steer the vehicle 1100 (e.g., along a desired path or route) when the propulsion system 1150 is operating (e.g., when the vehicle is in motion). The steering system 1154 may receive signals from a steering actuator 1156. The steering wheel may be optional for full automation (Level 5) functionality.

The brake sensor system 1146 may be used to operate the vehicle brakes in response to receiving signals from the brake actuators 1148 and/or brake sensors.

Controller(s) 1136, which may include one or more system on chips (SoCs) 1104 (FIG. 11C) and/or GPU(s), may provide signals (e.g., representative of commands) to one or more components and/or systems of the vehicle 1100. For example, the controller(s) may send signals to operate the vehicle brakes via one or more brake actuators 1148, to operate the steering system 1154 via one or more steering actuators 1156, to operate the propulsion system 1150 via one or more throttle/accelerators 1152. The controller(s) 1136 may include one or more onboard (e.g., integrated) computing devices (e.g., supercomputers) that process sensor signals, and output operation commands (e.g., signals representing commands) to enable autonomous driving and/or to assist a human driver in driving the vehicle 1100. The controller(s) 1136 may include a first controller 1136 for autonomous driving functions, a second controller 1136 for functional safety functions, a third controller 1136 for artificial intelligence functionality (e.g., computer vision), a fourth controller 1136 for infotainment functionality, a fifth controller 1136 for redundancy in emergency conditions, and/or other controllers. In some examples, a single controller 1136 may handle two or more of the above functionalities, two or more controllers 1136 may handle a single functionality, and/or any combination thereof.

The controller(s) 1136 may provide the signals for controlling one or more components and/or systems of the vehicle 1100 in response to sensor data received from one or more sensors (e.g., sensor inputs). The sensor data may be received from, for example and without limitation, global navigation satellite systems (“GNSS”) sensor(s) 1158 (e.g., Global Positioning System sensor(s)), RADAR sensor(s) 1160, ultrasonic sensor(s) 1162, LIDAR sensor(s) 1164, inertial measurement unit (IMU) sensor(s) 1166 (e.g., accelerometer(s), gyroscope(s), magnetic compass(es), magnetometer(s), etc.), microphone(s) 1196, stereo camera(s) 1168, wide-view camera(s) 1170 (e.g., fisheye cameras), infrared camera(s) 1172, surround camera(s) 1174 (e.g., 360 degree cameras), long-range and/or mid-range camera(s) 1198, speed sensor(s) 1144 (e.g., for measuring the speed of the vehicle 1100), vibration sensor(s) 1142, steering sensor(s) 1140, brake sensor(s) (e.g., as part of the brake sensor system 1146), and/or other sensor types.

One or more of the controller(s) 1136 may receive inputs (e.g., represented by input data) from an instrument cluster 1132 of the vehicle 1100 and provide outputs (e.g., represented by output data, display data, etc.) via a human-machine interface (HMI) display 1134, an audible annunciator, a loudspeaker, and/or via other components of the vehicle 1100. The outputs may include information such as vehicle velocity, speed, time, map data (e.g., the High Definition (“HD”) map 1122 of FIG. 11C), location data (e.g., the vehicle's 1100 location, such as on a map), direction, location of other vehicles (e.g., an occupancy grid), information about objects and status of objects as perceived by the controller(s) 1136, etc. For example, the HMI display 1134 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1100 further includes a network interface 1124 which may use one or more wireless antenna(s) 1126 and/or modem(s) to communicate over one or more networks. For example, the network interface 1124 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1126 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 11B is an example of camera locations and fields of view for the example autonomous vehicle 1100 of FIG. 11A, in accordance with some embodiments of the present disclosure. The cameras and respective fields of view are one example embodiment and are not intended to be limiting. For example, additional and/or alternative cameras may be included and/or the cameras may be located at different locations on the vehicle 1100.

The camera types for the cameras may include, but are not limited to, digital cameras that may be adapted for use with the components and/or systems of the vehicle 1100. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1100 (e.g., front-facing cameras) may be used for surround view, to help identify forward facing paths and obstacles, as well aid in, with the help of one or more controllers 1136 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1170 that may be used to perceive objects coming into view from the periphery (e.g., pedestrians, crossing traffic or bicycles). Although only one wide-view camera is illustrated in FIG. 11B, there may be any number (including zero) of wide-view cameras 1170 on the vehicle 1100. In addition, any number of long-range camera(s) 1198 (e.g., a long-view stereo camera pair) may be used for depth-based object detection, especially for objects for which a neural network has not yet been trained. The long-range camera(s) 1198 may also be used for object detection and classification, as well as basic object tracking.

Any number of stereo cameras 1168 may also be included in a front-facing configuration. In at least one embodiment, one or more of stereo camera(s) 1168 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1168 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1168 may be used in addition to, or alternatively from, those described herein.

Cameras with a field of view that include portions of the environment to the side of the vehicle 1100 (e.g., side-view cameras) may be used for surround view, providing information used to create and update the occupancy grid, as well as to generate side impact collision warnings. For example, surround camera(s) 1174 (e.g., four surround cameras 1174 as illustrated in FIG. 11B) may be positioned to on the vehicle 1100. The surround camera(s) 1174 may include wide-view camera(s) 1170, fisheye camera(s), 360 degree camera(s), and/or the like. Four example, four fisheye cameras may be positioned on the vehicle's front, rear, and sides. In an alternative arrangement, the vehicle may use three surround camera(s) 1174 (e.g., left, right, and rear), and may leverage one or more other camera(s) (e.g., a forward-facing camera) as a fourth surround view camera.

Cameras with a field of view that include portions of the environment to the rear of the vehicle 1100 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1198, stereo camera(s) 1168), infrared camera(s) 1172, etc.), as described herein.

FIG. 11C is a block diagram of an example system architecture for the example autonomous vehicle 1100 of FIG. 11A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1100 in FIG. 11C are illustrated as being connected via bus 1102. The bus 1102 may include a Controller Area Network (CAN) data interface (alternatively referred to herein as a “CAN bus”). A CAN may be a network inside the vehicle 1100 used to aid in control of various features and functionality of the vehicle 1100, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1102 is described herein as being a CAN bus, this is not intended to be limiting. For example, in addition to, or alternatively from, the CAN bus, FlexRay and/or Ethernet may be used. Additionally, although a single line is used to represent the bus 1102, this is not intended to be limiting. For example, there may be any number of busses 1102, which may include one or more CAN busses, one or more FlexRay busses, one or more Ethernet busses, and/or one or more other types of busses using a different protocol. In some examples, two or more busses 1102 may be used to perform different functions, and/or may be used for redundancy. For example, a first bus 1102 may be used for collision avoidance functionality and a second bus 1102 may be used for actuation control. In any example, each bus 1102 may communicate with any of the components of the vehicle 1100, and two or more busses 1102 may communicate with the same components. In some examples, each SoC 1104, each controller 1136, and/or each computer within the vehicle may have access to the same input data (e.g., inputs from sensors of the vehicle 1100), and may be connected to a common bus, such the CAN bus.

The vehicle 1100 may include one or more controller(s) 1136, such as those described herein with respect to FIG. 11A. The controller(s) 1136 may be used for a variety of functions. The controller(s) 1136 may be coupled to any of the various other components and systems of the vehicle 1100, and may be used for control of the vehicle 1100, artificial intelligence of the vehicle 1100, infotainment for the vehicle 1100, and/or the like.

The vehicle 1100 may include a system(s) on a chip (SoC) 1104. The SoC 1104 may include CPU(s) 1106, GPU(s) 1108, processor(s) 1110, cache(s) 1112, accelerator(s) 1114, data store(s) 1116, and/or other components and features not illustrated. The SoC(s) 1104 may be used to control the vehicle 1100 in a variety of platforms and systems. For example, the SoC(s) 1104 may be combined in a system (e.g., the system of the vehicle 1100) with an HD map 1122 which may obtain map refreshes and/or updates via a network interface 1124 from one or more servers (e.g., server(s) 1178 of FIG. 11D).

The CPU(s) 1106 may include a CPU cluster or CPU complex (alternatively referred to herein as a “CCPLEX”). The CPU(s) 1106 may include multiple cores and/or L2 caches. For example, in some embodiments, the CPU(s) 1106 may include eight cores in a coherent multi-processor configuration. In some embodiments, the CPU(s) 1106 may include four dual-core clusters where each cluster has a dedicated L2 cache (e.g., a 2 MB L2 cache). The CPU(s) 1106 (e.g., the CCPLEX) may be configured to support simultaneous cluster operation enabling any combination of the clusters of the CPU(s) 1106 to be active at any given time.

The CPU(s) 1106 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1106 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1108 may include an integrated GPU (alternatively referred to herein as an “iGPU”). The GPU(s) 1108 may be programmable and may be efficient for parallel workloads. The GPU(s) 1108, in some examples, may use an enhanced tensor instruction set. The GPU(s) 1108 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1108 may include at least eight streaming microprocessors. The GPU(s) 1108 may use compute application programming interface(s) (API(s)). In addition, the GPU(s) 1108 may use one or more parallel computing platforms and/or programming models (e.g., NVIDIA's CUDA).

The GPU(s) 1108 may be power-optimized for best performance in automotive and embedded use cases. For example, the GPU(s) 1108 may be fabricated on a Fin field-effect transistor (FinFET). However, this is not intended to be limiting and the GPU(s) 1108 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-points data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1108 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1108 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1108 to access the CPU(s) 1106 page tables directly. In such examples, when the GPU(s) 1108 memory management unit (MMU) experiences a miss, an address translation request may be transmitted to the CPU(s) 1106. In response, the CPU(s) 1106 may look in its page tables for the virtual-to-physical mapping for the address and transmits the translation back to the GPU(s) 1108. As such, unified memory technology may allow a single unified virtual address space for memory of both the CPU(s) 1106 and the GPU(s) 1108, thereby simplifying the GPU(s) 1108 programming and porting of applications to the GPU(s) 1108.

In addition, the GPU(s) 1108 may include an access counter that may keep track of the frequency of access of the GPU(s) 1108 to memory of other processors. The access counter may help ensure that memory pages are moved to the physical memory of the processor that is accessing the pages most frequently.

The SoC(s) 1104 may include any number of cache(s) 1112, including those described herein. For example, the cache(s) 1112 may include an L3 cache that is available to both the CPU(s) 1106 and the GPU(s) 1108 (e.g., that is connected both the CPU(s) 1106 and the GPU(s) 1108). The cache(s) 1112 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1104 may include an arithmetic logic unit(s) (ALU(s)) which may be leveraged in performing processing with respect to any of the variety of tasks or operations of the vehicle 1100—such as processing DNNs. In addition, the SoC(s) 1104 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 1106 and/or GPU(s) 1108.

The SoC(s) 1104 may include one or more accelerators 1114 (e.g., hardware accelerators, software accelerators, or a combination thereof). For example, the SoC(s) 1104 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1108 and to off-load some of the tasks of the GPU(s) 1108 (e.g., to free up more cycles of the GPU(s) 1108 for performing other tasks). As an example, the accelerator(s) 1114 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1114 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1108, and by using an inference accelerator, for example, a designer may target either the DLA(s) or the GPU(s) 1108 for any function. For example, the designer may focus processing of CNNs and floating point operations on the DLA(s) and leave other functions to the GPU(s) 1108 and/or other accelerator(s) 1114.

The accelerator(s) 1114 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1106. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1114 (e.g., the hardware acceleration cluster) may include a computer vision network on-chip and SRAM, for providing a high-bandwidth, low latency SRAM for the accelerator(s) 1114. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1104 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1114 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1166 output that correlates with the vehicle 1100 orientation, distance, 3D location estimates of the object obtained from the neural network and/or other sensors (e.g., LIDAR sensor(s) 1164 or RADAR sensor(s) 1160), among others.

The SoC(s) 1104 may include data store(s) 1116 (e.g., memory). The data store(s) 1116 may be on-chip memory of the SoC(s) 1104, which may store neural networks to be executed on the GPU and/or the DLA. In some examples, the data store(s) 1116 may be large enough in capacity to store multiple instances of neural networks for redundancy and safety. The data store(s) 1112 may comprise L2 or L3 cache(s) 1112. Reference to the data store(s) 1116 may include reference to the memory associated with the PVA, DLA, and/or other accelerator(s) 1114, as described herein.

The SoC(s) 1104 may include one or more processor(s) 1110 (e.g., embedded processors). The processor(s) 1110 may include a boot and power management processor that may be a dedicated processor and subsystem to handle boot power and management functions and related security enforcement. The boot and power management processor may be a part of the SoC(s) 1104 boot sequence and may provide runtime power management services. The boot power and management processor may provide clock and voltage programming, assistance in system low power state transitions, management of SoC(s) 1104 thermals and temperature sensors, and/or management of the SoC(s) 1104 power states. Each temperature sensor may be implemented as a ring-oscillator whose output frequency is proportional to temperature, and the SoC(s) 1104 may use the ring-oscillators to detect temperatures of the CPU(s) 1106, GPU(s) 1108, and/or accelerator(s) 1114. If temperatures are determined to exceed a threshold, the boot and power management processor may enter a temperature fault routine and put the SoC(s) 1104 into a lower power state and/or put the vehicle 1100 into a chauffeur to safe stop mode (e.g., bring the vehicle 1100 to a safe stop).

The processor(s) 1110 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1110 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1110 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1110 may further include a real-time camera engine that may include a dedicated processor subsystem for handling real-time camera management.

The processor(s) 1110 may further include a high-dynamic range signal processor that may include an image signal processor that is a hardware engine that is part of the camera processing pipeline.

The processor(s) 1110 may include a video image compositor that may be a processing block (e.g., implemented on a microprocessor) that implements video post-processing functions needed by a video playback application to produce the final image for the player window. The video image compositor may perform lens distortion correction on wide-view camera(s) 1170, surround camera(s) 1174, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1108 is not required to continuously render new surfaces. Even when the GPU(s) 1108 is powered on and active doing 3D rendering, the video image compositor may be used to offload the GPU(s) 1108 to improve performance and responsiveness.

The SoC(s) 1104 may further include a mobile industry processor interface (MIPI) camera serial interface for receiving video and input from cameras, a high-speed interface, and/or a video input block that may be used for camera and related pixel input functions. The SoC(s) 1104 may further include an input/output controller(s) that may be controlled by software and may be used for receiving I/O signals that are uncommitted to a specific role.

The SoC(s) 1104 may further include a broad range of peripheral interfaces to enable communication with peripherals, audio codecs, power management, and/or other devices. The SoC(s) 1104 may be used to process data from cameras (e.g., connected over Gigabit Multimedia Serial Link and Ethernet), sensors (e.g., LIDAR sensor(s) 1164, RADAR sensor(s) 1160, etc. that may be connected over Ethernet), data from bus 1102 (e.g., speed of vehicle 1100, steering wheel position, etc.), data from GNSS sensor(s) 1158 (e.g., connected over Ethernet or CAN bus). The SoC(s) 1104 may further include dedicated high-performance mass storage controllers that may include their own DMA engines, and that may be used to free the CPU(s) 1106 from routine data management tasks.

The SoC(s) 1104 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1104 may be faster, more reliable, and even more energy-efficient and space-efficient than conventional systems. For example, the accelerator(s) 1114, when combined with the CPU(s) 1106, the GPU(s) 1108, and the data store(s) 1116, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1120) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1108.

In some examples, a CNN for facial recognition and vehicle owner identification may use data from camera sensors to identify the presence of an authorized driver and/or owner of the vehicle 1100. The always on sensor processing engine may be used to unlock the vehicle when the owner approaches the driver door and turn on the lights, and, in security mode, to disable the vehicle when the owner leaves the vehicle. In this way, the SoC(s) 1104 provide for security against theft and/or carjacking.

In another example, a CNN for emergency vehicle detection and identification may use data from microphones 1196 to detect and identify emergency vehicle sirens. In contrast to conventional systems, that use general classifiers to detect sirens and manually extract features, the SoC(s) 1104 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1158. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1162, until the emergency vehicle(s) passes.

The vehicle may include a CPU(s) 1118 (e.g., discrete CPU(s), or dCPU(s)), that may be coupled to the SoC(s) 1104 via a high-speed interconnect (e.g., PCIe). The CPU(s) 1118 may include an X86 processor, for example. The CPU(s) 1118 may be used to perform any of a variety of functions, including arbitrating potentially inconsistent results between ADAS sensors and the SoC(s) 1104, and/or monitoring the status and health of the controller(s) 1136 and/or infotainment SoC 1130, for example.

The vehicle 1100 may include a GPU(s) 1120 (e.g., discrete GPU(s), or dGPU(s)), that may be coupled to the SoC(s) 1104 via a high-speed interconnect (e.g., NVIDIA's NVLINK). The GPU(s) 1120 may provide additional artificial intelligence functionality, such as by executing redundant and/or different neural networks, and may be used to train and/or update neural networks based on input (e.g., sensor data) from sensors of the vehicle 1100.

The vehicle 1100 may further include the network interface 1124 which may include one or more wireless antennas 1126 (e.g., one or more wireless antennas for different communication protocols, such as a cellular antenna, a Bluetooth antenna, etc.). The network interface 1124 may be used to enable wireless connectivity over the Internet with the cloud (e.g., with the server(s) 1178 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1100 information about vehicles in proximity to the vehicle 1100 (e.g., vehicles in front of, on the side of, and/or behind the vehicle 1100). This functionality may be part of a cooperative adaptive cruise control functionality of the vehicle 1100.

The network interface 1124 may include a SoC that provides modulation and demodulation functionality and enables the controller(s) 1136 to communicate over wireless networks. The network interface 1124 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1100 may further include data store(s) 1128 which may include off-chip (e.g., off the SoC(s) 1104) storage. The data store(s) 1128 may include one or more storage elements including RAM, SRAM, DRAM, VRAM, Flash, hard disks, and/or other components and/or devices that may store at least one bit of data.

The vehicle 1100 may further include GNSS sensor(s) 1158. The GNSS sensor(s) 1158 (e.g., GPS, assisted GPS sensors, differential GPS (DGPS) sensors, etc.), to assist in mapping, perception, occupancy grid generation, and/or path planning functions. Any number of GNSS sensor(s) 1158 may be used, including, for example and without limitation, a GPS using a USB connector with an Ethernet to Serial (RS-232) bridge.

The vehicle 1100 may further include RADAR sensor(s) 1160. The RADAR sensor(s) 1160 may be used by the vehicle 1100 for long-range vehicle detection, even in darkness and/or severe weather conditions. RADAR functional safety levels may be ASIL B. The RADAR sensor(s) 1160 may use the CAN and/or the bus 1102 (e.g., to transmit data generated by the RADAR sensor(s) 1160) for control and to access object tracking data, with access to Ethernet to access raw data in some examples. A wide variety of RADAR sensor types may be used. For example, and without limitation, the RADAR sensor(s) 1160 may be suitable for front, rear, and side RADAR use. In some example, Pulse Doppler RADAR sensor(s) are used.

The RADAR sensor(s) 1160 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1160 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1100 surroundings at higher speeds with minimal interference from traffic in adjacent lanes. The other two antennae may expand the field of view, making it possible to quickly detect vehicles entering or leaving the vehicle's 1100 lane.

Mid-range RADAR systems may include, as an example, a range of up to 1160 m (front) or 80 m (rear), and a field of view of up to 42 degrees (front) or 1150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1100 may further include ultrasonic sensor(s) 1162. The ultrasonic sensor(s) 1162, which may be positioned at the front, back, and/or the sides of the vehicle 1100, may be used for park assist and/or to create and update an occupancy grid. A wide variety of ultrasonic sensor(s) 1162 may be used, and different ultrasonic sensor(s) 1162 may be used for different ranges of detection (e.g., 2.5 m, 4 m). The ultrasonic sensor(s) 1162 may operate at functional safety levels of ASIL B.

The vehicle 1100 may include LIDAR sensor(s) 1164. The LIDAR sensor(s) 1164 may be used for object and pedestrian detection, emergency braking, collision avoidance, and/or other functions. The LIDAR sensor(s) 1164 may be functional safety level ASIL B. In some examples, the vehicle 1100 may include multiple LIDAR sensors 1164 (e.g., two, four, six, etc.) that may use Ethernet (e.g., to provide data to a Gigabit Ethernet switch).

In some examples, the LIDAR sensor(s) 1164 may be capable of providing a list of objects and their distances for a 360-degree field of view. Commercially available LIDAR sensor(s) 1164 may have an advertised range of approximately 1100 m, with an accuracy of 2 cm-3 cm, and with support for a 1100 Mbps Ethernet connection, for example. In some examples, one or more non-protruding LIDAR sensors 1164 may be used. In such examples, the LIDAR sensor(s) 1164 may be implemented as a small device that may be embedded into the front, rear, sides, and/or corners of the vehicle 1100. The LIDAR sensor(s) 1164, in such examples, may provide up to a 120-degree horizontal and 35-degree vertical field-of-view, with a 200 m range even for low-reflectivity objects. Front-mounted LIDAR sensor(s) 1164 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1100. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1164 may be less susceptible to motion blur, vibration, and/or shock.

The vehicle may further include IMU sensor(s) 1166. The IMU sensor(s) 1166 may be located at a center of the rear axle of the vehicle 1100, in some examples. The IMU sensor(s) 1166 may include, for example and without limitation, an accelerometer(s), a magnetometer(s), a gyroscope(s), a magnetic compass(es), and/or other sensor types. In some examples, such as in six-axis applications, the IMU sensor(s) 1166 may include accelerometers and gyroscopes, while in nine-axis applications, the IMU sensor(s) 1166 may include accelerometers, gyroscopes, and magnetometers.

In some embodiments, the IMU sensor(s) 1166 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1166 may enable the vehicle 1100 to estimate heading without requiring input from a magnetic sensor by directly observing and correlating the changes in velocity from GPS to the IMU sensor(s) 1166. In some examples, the IMU sensor(s) 1166 and the GNSS sensor(s) 1158 may be combined in a single integrated unit.

The vehicle may include microphone(s) 1196 placed in and/or around the vehicle 1100. The microphone(s) 1196 may be used for emergency vehicle detection and identification, among other things.

The vehicle may further include any number of camera types, including stereo camera(s) 1168, wide-view camera(s) 1170, infrared camera(s) 1172, surround camera(s) 1174, long-range and/or mid-range camera(s) 1198, and/or other camera types. The cameras may be used to capture image data around an entire periphery of the vehicle 1100. The types of cameras used depends on the embodiments and requirements for the vehicle 1100, and any combination of camera types may be used to provide the necessary coverage around the vehicle 1100. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 11A and FIG. 11B.

The vehicle 1100 may further include vibration sensor(s) 1142. The vibration sensor(s) 1142 may measure vibrations of components of the vehicle, such as the axle(s). For example, changes in vibrations may indicate a change in road surfaces. In another example, when two or more vibration sensors 1142 are used, the differences between the vibrations may be used to determine friction or slippage of the road surface (e.g., when the difference in vibration is between a power-driven axle and a freely rotating axle).

The vehicle 1100 may include an ADAS system 1138. The ADAS system 1138 may include a SoC, in some examples. The ADAS system 1138 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1160, LIDAR sensor(s) 1164, and/or a camera(s). The ACC systems may include longitudinal ACC and/or lateral ACC. Longitudinal ACC monitors and controls the distance to the vehicle immediately ahead of the vehicle 1100 and automatically adjust the vehicle speed to maintain a safe distance from vehicles ahead. Lateral ACC performs distance keeping, and advises the vehicle 1100 to change lanes when necessary. Lateral ACC is related to other ADAS applications such as LCA and CWS.

CACC uses information from other vehicles that may be received via the network interface 1124 and/or the wireless antenna(s) 1126 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1100), while the I2V communication concept provides information about traffic further ahead. CACC systems may include either or both I2V and V2V information sources. Given the information of the vehicles ahead of the vehicle 1100, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1160, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1160, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1100 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1100 if the vehicle 1100 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1160, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1100 is backing up. Some RCTW systems include AEB to ensure that the vehicle brakes are applied to avoid a crash. RCTW systems may use one or more rear-facing RADAR sensor(s) 1160, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1100, the vehicle 1100 itself must, in the case of conflicting results, decide whether to heed the result from a primary computer or a secondary computer (e.g., a first controller 1136 or a second controller 1136). For example, in some embodiments, the ADAS system 1138 may be a backup and/or secondary computer for providing perception information to a backup computer rationality module. The backup computer rationality monitor may run a redundant diverse software on hardware components to detect faults in perception and dynamic driving tasks. Outputs from the ADAS system 1138 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1104.

In other examples, ADAS system 1138 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1138 may be fed into the primary computer's perception block and/or the primary computer's dynamic driving task block. For example, if the ADAS system 1138 indicates a forward crash warning due to an object immediately ahead, the perception block may use this information when identifying objects. In other examples, the secondary computer may have its own neural network which is trained and thus reduces the risk of false positives, as described herein.

The vehicle 1100 may further include the infotainment SoC 1130 (e.g., an in-vehicle infotainment system (IVI)). Although illustrated and described as a SoC, the infotainment system may not be a SoC, and may include two or more discrete components. The infotainment SoC 1130 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1100. For example, the infotainment SoC 1130 may radios, disk players, navigation systems, video players, USB and Bluetooth connectivity, carputers, in-car entertainment, Wi-Fi, steering wheel audio controls, hands free voice control, a heads-up display (HUD), an HMI display 1134, a telematics device, a control panel (e.g., for controlling and/or interacting with various components, features, and/or systems), and/or other components. The infotainment SoC 1130 may further be used to provide information (e.g., visual and/or audible) to a user(s) of the vehicle, such as information from the ADAS system 1138, autonomous driving information such as planned vehicle maneuvers, trajectories, surrounding environment information (e.g., intersection information, vehicle information, road information, etc.), and/or other information.

The infotainment SoC 1130 may include GPU functionality. The infotainment SoC 1130 may communicate over the bus 1102 (e.g., CAN bus, Ethernet, etc.) with other devices, systems, and/or components of the vehicle 1100. In some examples, the infotainment SoC 1130 may be coupled to a supervisory MCU such that the GPU of the infotainment system may perform some self-driving functions in the event that the primary controller(s) 1136 (e.g., the primary and/or backup computers of the vehicle 1100) fail. In such an example, the infotainment SoC 1130 may put the vehicle 1100 into a chauffeur to safe stop mode, as described herein.

The vehicle 1100 may further include an instrument cluster 1132 (e.g., a digital dash, an electronic instrument cluster, a digital instrument panel, etc.). The instrument cluster 1132 may include a controller and/or supercomputer (e.g., a discrete controller or supercomputer). The instrument cluster 1132 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1130 and the instrument cluster 1132. In other words, the instrument cluster 1132 may be included as part of the infotainment SoC 1130, or vice versa.

FIG. 11D is a system diagram for communication between cloud-based server(s) and the example autonomous vehicle 1100 of FIG. 11A, in accordance with some embodiments of the present disclosure. The system 1176 may include server(s) 1178, network(s) 1190, and vehicles, including the vehicle 1100. The server(s) 1178 may include a plurality of GPUs 1184(A)-1184(H) (collectively referred to herein as GPUs 1184), PCIe switches 1182(A)-1182(H) (collectively referred to herein as PCIe switches 1182), and/or CPUs 1180(A)-1180(B) (collectively referred to herein as CPUs 1180). The GPUs 1184, the CPUs 1180, and the PCIe switches may be interconnected with high-speed interconnects such as, for example and without limitation, NVLink interfaces 1188 developed by NVIDIA and/or PCIe connections 1186. In some examples, the GPUs 1184 are connected via NVLink and/or NVSwitch SoC and the GPUs 1184 and the PCIe switches 1182 are connected via PCIe interconnects. Although eight GPUs 1184, two CPUs 1180, and two PCIe switches are illustrated, this is not intended to be limiting. Depending on the embodiment, each of the server(s) 1178 may include any number of GPUs 1184, CPUs 1180, and/or PCIe switches. For example, the server(s) 1178 may each include eight, sixteen, thirty-two, and/or more GPUs 1184.

The server(s) 1178 may receive, over the network(s) 1190 and from the vehicles, image data representative of images showing unexpected or changed road conditions, such as recently commenced road-work. The server(s) 1178 may transmit, over the network(s) 1190 and to the vehicles, neural networks 1192, updated neural networks 1192, and/or map information 1194, including information regarding traffic and road conditions. The updates to the map information 1194 may include updates for the HD map 1122, such as information regarding construction sites, potholes, detours, flooding, and/or other obstructions. In some examples, the neural networks 1192, the updated neural networks 1192, and/or the map information 1194 may have resulted from new training and/or experiences represented in data received from any number of vehicles in the environment, and/or based on training performed at a datacenter (e.g., using the server(s) 1178 and/or other servers).

The server(s) 1178 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1190, and/or the machine learning models may be used by the server(s) 1178 to remotely monitor the vehicles.

In some examples, the server(s) 1178 may receive data from the vehicles and apply the data to up-to-date real-time neural networks for real-time intelligent inferencing. The server(s) 1178 may include deep-learning supercomputers and/or dedicated AI computers powered by GPU(s) 1184, such as a DGX and DGX Station machines developed by NVIDIA. However, in some examples, the server(s) 1178 may include deep learning infrastructure that use only CPU-powered datacenters.

The deep-learning infrastructure of the server(s) 1178 may be capable of fast, real-time inferencing, and may use that capability to evaluate and verify the health of the processors, software, and/or associated hardware in the vehicle 1100. For example, the deep-learning infrastructure may receive periodic updates from the vehicle 1100, such as a sequence of images and/or objects that the vehicle 1100 has located in that sequence of images (e.g., via computer vision and/or other machine learning object classification techniques). The deep-learning infrastructure may run its own neural network to identify the objects and compare them with the objects identified by the vehicle 1100 and, if the results do not match and the infrastructure concludes that the AI in the vehicle 1100 is malfunctioning, the server(s) 1178 may transmit a signal to the vehicle 1100 instructing a fail-safe computer of the vehicle 1100 to assume control, notify the passengers, and complete a safe parking maneuver.

For inferencing, the server(s) 1178 may include the GPU(s) 1184 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). In other words, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that enable the computing device 1200 to communicate with other computing devices via an electronic communication network, included wired and/or wireless communications. The communication interface 1210 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may enable the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that enable detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to enable the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R. s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1333, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may utilize distributed file system 1338 for large-scale data processing (e.g., “big data”). In at least one embodiment, job scheduler 1333 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1333. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

The data center 1300 may include one or more components, such as one or more central processing units (CPUs), one or more graphics processing units (GPUs), one or more isolated trusted execution environments (TEEs), one or more interconnects for multi-GPU communication; one or more data processing units (DPUs), and one or more network interface chips (NICs).

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments - in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Clauses

A: A method comprising: generating one or more input tokens representative of one or more first points associated with a road marking as depicted by an image associated with a map; generating one or more embeddings associated with the image; generating, using one or more machine learning models and based at least on the one or more input tokens and the one or more embeddings, one or more output tokens representative of one or more second points associated with the road marking; generating a line representation of the road marking based at least on the one or more second points; and updating, based at least on the line representation, the map to include a label associated with the road marking.

B: The method of paragraph A, further comprising at least one of: receiving input data representative of the one or more first points associated with the road marking; or determining, based at least on analyzing at least one of the map or the image, the one or more first points associated with the road marking.

C: The method of either paragraph A or paragraph B, wherein the generating the one or more output tokens comprises: generating, using the one or more machine learning models and based at least on the one or more input tokens and the one or more embeddings, one or more first output tokens representative of a first portion of the one or more second points; and generating, using the one or more machine learning models and based at least on the one or more first output tokens, one or more second output tokens representative of a second portion of the one or more second points.

D: The method of any one of paragraphs A-C, further comprising: generating, using the one or more machine learning models and based at least on the one or more input tokens and the one or more embeddings, one or more image tokens associated with the image, wherein the generating the line representation is further based at least on the one or more image tokens.

E: The method of any one of paragraphs A-D, further comprising: appending the one or more input tokens to one or more learnable tokens to generate one or more appended input tokens, wherein the generating the one or more output tokens is based at least on the one or more appended input tokens and the one or more embeddings.

F: The method of any one of paragraphs A-E, further comprising: determining, based at least on the one or more output tokens, one or more classifications associated with the one or more second points, wherein the generating the line representation is further based at least on the one or more classifications.

G: The method of any one of paragraphs A-F, further comprising: generating, using one or more decoders and based at least on the one or more output tokens, one or more coordinates associated with the one or more second points within the image, wherein the generating the line representation is based at least on the one or more coordinates.

H: The method of any one of paragraphs A-G, further comprising: generating, based at least on at least one of the one or more output tokens or one or more image tokens associated with the image, a heatmap associated with the road marking, wherein the generating the line representation is further based at least on the heatmap.

I: A data center comprising: one or more central processing units (CPUs); one or more graphics processing units (GPUs); one or more isolated trusted execution environments (TEEs); one or more interconnects for multi-GPU communication; one or more data processing units (DPUs); one or more network interface chips (NICs); wherein one or more components of the data center are to: determine one or more first points associated with a traffic feature from within a sensor data representation corresponding to a map; determine, using one or more machine learning models and based at least on input data associated with the one or more first points and the sensor data representation, one or more second points associated with the traffic feature; generate a representation of the traffic feature based at least on the one or more second points; and update, based at least on the representation, the map to include information associated with the traffic feature.

J: The data center of paragraph I, wherein the one or more components are further to: generate one or more input tokens based at least on the one or more first points and one or more embeddings based at least on the sensor data representation, wherein the input data is associated with the one or more input tokens and the one or more embeddings.

K: The data center of paragraph J, wherein the one or more components are further to: append the one or more input tokens to one or more learnable tokens to generate one or more appended input tokens, wherein the input data is associated with the one or more appended input tokens and the one or more embeddings.

L: The data center of any one of paragraphs I-K, wherein the determination of the one or more second points associated with the traffic feature comprises: generating, using the one or more machine learning models and based at least on the input data, one or more output tokens; and determining, based at least on the one or more output tokens, the one or more second points associated with the traffic feature.

M: The data center of any one of paragraphs I-L, wherein the one or more components are further to perform at least one of: receive one or more inputs representing the one or more first points associated with the traffic feature; or determine, based at least on analyzing at least one of the map or the sensor data representation, the one or more first points associated with the traffic feature.

N: The data center of any one of paragraphs I-M, wherein the determination of the one or more second points associated with the traffic feature comprises: determining, using the one or more machine learning models and based at least on the input data, at least a first portion of the one or more second points; and determining, using the one or more machine learning models and based at least on second input data associated with the at least the first portion of the one or more second points, at least a second portion of the one or more second points.

O: The data center of any one of paragraphs I-N, wherein the one or more components are further to: determine, using the one or more machine learning models and based at least on the input data, one or more classifications associated with the one or more second points, wherein the representation is further generated based at least on the one or more classifications.

P: The data center of any one of paragraphs I-O, wherein the one or more components are further to: determine, using the one or more machine learning models and based at least on the input data, a heatmap associated with the traffic feature, wherein the representation is further generated based at least on the heatmap.

Q: The data center of any one of paragraphs I-P, wherein: the traffic feature includes a road marking as represented by the sensor data representation corresponding to the map; the one or more processors are further to determine, based at least on the sensor data representation, a type of marking associated with the road marking; and the map is further updated to indicate the type of marking.

R: The data center of any one of paragraphs I-Q, wherein the data center is comprised in or is used in conjunction with at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

S: One or more processors comprising: processing circuitry to generate a line representation associated with a traffic feature as represented by a map, wherein the line representation is generated based at least on: one or more encoders of one or more machine learning models generating one or more input tokens associated with one or more first points of the traffic feature and one or more image embeddings associated with an image of the traffic feature; and one or more decoders of the one or more machine learning models processing the one or more input tokens and the one or more embeddings to determine one or more second points associate with the line representation.

T: The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

What is claimed is:

1. A method comprising:
generating one or more input tokens representative of one or more first points associated with a road marking as depicted by an image associated with a map;
generating one or more embeddings associated with the image;
generating, using one or more machine learning models and based at least on the one or more input tokens and the one or more embeddings, one or more output tokens representative of one or more second points associated with the road marking;
generating a line representation of the road marking based at least on the one or more second points; and
updating, based at least on the line representation, the map to include a label associated with the road marking.

2. The method of claim 1, further comprising at least one of:
receiving input data representative of the one or more first points associated with the road marking; or
determining, based at least on analyzing at least one of the map or the image, the one or more first points associated with the road marking.

3. The method of claim 1, wherein the generating the one or more output tokens comprises:
generating, using the one or more machine learning models and based at least on the one or more input tokens and the one or more embeddings, one or more first output tokens representative of a first portion of the one or more second points; and
generating, using the one or more machine learning models and based at least on the one or more first output tokens, one or more second output tokens representative of a second portion of the one or more second points.

4. The method of claim 1, further comprising:
generating, using the one or more machine learning models and based at least on the one or more input tokens and the one or more embeddings, one or more image tokens associated with the image,
wherein the generating the line representation is further based at least on the one or more image tokens.

5. The method of claim 1, further comprising:
appending the one or more input tokens to one or more learnable tokens to generate one or more appended input tokens,
wherein the generating the one or more output tokens is based at least on the one or more appended input tokens and the one or more embeddings.

6. The method of claim 1, further comprising:
determining, based at least on the one or more output tokens, one or more classifications associated with the one or more second points,
wherein the generating the line representation is further based at least on the one or more classifications.

7. The method of claim 1, further comprising:
generating, using one or more decoders and based at least on the one or more output tokens, one or more coordinates associated with the one or more second points within the image,
wherein the generating the line representation is based at least on the one or more coordinates.

8. The method of claim 1, further comprising:
generating, based at least on at least one of the one or more output tokens or one or more image tokens associated with the image, a heatmap associated with the road marking,
wherein the generating the line representation is further based at least on the heatmap.

9. A data center comprising:
one or more central processing units (CPUs);
one or more graphics processing units (GPUs);
one or more isolated trusted execution environments (TEEs);
one or more interconnects for multi-GPU communication;
one or more data processing units (DPUs);
one or more network interface chips (NICs);
wherein one or more components of the data center are to:
determine one or more first points associated with a traffic feature from within a sensor data representation corresponding to a map;
determine, using one or more machine learning models and based at least on input data associated with the one or more first points and the sensor data representation, one or more second points associated with the traffic feature;
generate a representation of the traffic feature based at least on the one or more second points; and
update, based at least on the representation, the map to include information associated with the traffic feature.

10. The data center of claim 9, wherein the one or more components are further to:
generate one or more input tokens based at least on the one or more first points and one or more embeddings based at least on the sensor data representation,
wherein the input data is associated with the one or more input tokens and the one or more embeddings.

11. The data center of claim 10, wherein the one or more components are further to:
append the one or more input tokens to one or more learnable tokens to generate one or more appended input tokens,
wherein the input data is associated with the one or more appended input tokens and the one or more embeddings.

12. The data center of claim 9, wherein the determination of the one or more second points associated with the traffic feature comprises:
generating, using the one or more machine learning models and based at least on the input data, one or more output tokens; and
determining, based at least on the one or more output tokens, the one or more second points associated with the traffic feature.

13. The data center of claim 9, wherein the one or more components are further to perform at least one of:
receive one or more inputs representing the one or more first points associated with the traffic feature; or
determine, based at least on analyzing at least one of the map or the sensor data representation, the one or more first points associated with the traffic feature.

14. The data center of claim 9, wherein the determination of the one or more second points associated with the traffic feature comprises:
determining, using the one or more machine learning models and based at least on the input data, at least a first portion of the one or more second points; and
determining, using the one or more machine learning models and based at least on second input data associated with the at least the first portion of the one or more second points, at least a second portion of the one or more second points.

15. The data center of claim 9, wherein the one or more components are further to:
determine, using the one or more machine learning models and based at least on the input data, one or more classifications associated with the one or more second points,
wherein the representation is further generated based at least on the one or more classifications.

16. The data center of claim 9, wherein the one or more components are further to:
determine, using the one or more machine learning models and based at least on the input data, a heatmap associated with the traffic feature,
wherein the representation is further generated based at least on the heatmap.

17. The data center of claim 9, wherein:
the traffic feature includes a road marking as represented by the sensor data representation corresponding to the map;
the one or more processors are further to determine, based at least on the sensor data representation, a type of marking associated with the road marking; and
the map is further updated to indicate the type of marking.

18. The data center of claim 9, wherein the data center is comprised in or is used in conjunction with at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

19. One or more processors comprising:
processing circuitry to generate a line representation associated with a traffic feature as represented by a map, wherein the line representation is generated based at least on:
one or more encoders of one or more machine learning models generating one or more input tokens associated with one or more first points of the traffic feature and one or more image embeddings associated with an image of the traffic feature; and
one or more decoders of the one or more machine learning models processing the one or more input tokens and the one or more embeddings to determine one or more second points associate with the line representation.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
